(19) United States
(12) Patent Application Publication
(10) Pub. No.: US 2026/0212098 A1
(43) Pub. Date: Jul. 23, 2026

(54) DUAL-EDGE PULSE MODELING IN CIRCUIT DESIGN TESTING

(71) Applicant: INTERNATIONAL BUSINESS MACHINES CORPORATION, Armonk, NY (US)

(72) Inventors: Manish Verma, Bangalore (IN); Michael Hemsley Wood, Wilmington, DE (US); Kerim Kalafala, Rhinebeck, NY (US); Hemlata Gupta, Hopewell Jct, NY (US)

(21) Appl. No.: 19/032,794

(22) Filed: Jan. 21, 2025

(51) Int. Cl. G06F 30/3312; G06F 30/333; G06F 119/12

(52) U.S. Cl. CPC G06F 30/3312; G06F 30/333; G06F 2119/12

(57) ABSTRACT

Circuit design testing includes identifying, from an input specification of a circuit, a dual-edge pulse clock that is based on a source clock specified in the input specification. The dual-edge pulse clock includes leading-edge pulses triggered based on leading edges of the source clock and trailing-edge pulses triggered based on trailing edges of the source clock. The method also includes modeling the dual-edge pulse clock by a set of clock signals for a timing analysis of the circuit. The set of clock signals includes one clock signal that models the leading-edge pulses of the dual-edge pulse clock and another clock signal that models the trailing-edge pulses of the dual-edge pulse clock.

### BACKGROUND

Aspects described herein relate to circuit testing, and more specifically to static timing analysis for a defined circuit. Static timing analysis is a software-based analysis method to simulate and analyze timing of a circuit based on an input description, or design specification, of the circuit. Typically, an input specification in the form of digital files, often including a netlist describing circuit components and connectivity, is loaded into software, and the software performs various timing-related tests based on simulating the performance of the designed circuit based on its specification. A purpose of this timing analysis is to ensure that the circuit as defined by the specification will operate as intended.

### SUMMARY

Shortcomings of the prior art are overcome and additional advantages are provided through the provision of a computer-implemented method. The method includes identifying, from an input specification of a circuit, a dual-edge pulse clock that is based on a source clock specified in the input specification. The dual-edge pulse clock includes leading-edge pulses triggered based on leading edges of the source clock and trailing-edge pulses triggered based on trailing edges of the source clock. The method also includes modeling the dual-edge pulse clock by a set of clock signals for a timing analysis of the circuit. The set of clock signals includes one clock signal that models the leading-edge pulses of the dual-edge pulse clock and another clock signal that models the trailing-edge pulses of the dual-edge pulse clock.

In one or more aspects, a computer system is provided. The computer system includes at least one computing device, a set of one or more computer readable storage media, and program instructions, collectively stored in the set of one or more computer readable storage media, for causing the at least one computing device to perform computer operations. The computer operations include identifying, from an input specification of a circuit, a dual-edge pulse clock that is based on a source clock specified in the input specification. The dual-edge pulse clock includes leading-edge pulses triggered based on leading edges of the source clock and trailing-edge pulses triggered based on trailing edges of the source clock. The method also includes modeling the dual-edge pulse clock by a set of clock signals for a timing analysis of the circuit. The set of clock signals includes one clock signal that models the leading-edge pulses of the dual-edge pulse clock and another clock signal that models the trailing-edge pulses of the dual-edge pulse clock.

In one or more aspects, a computer program product is provided. The computer program product includes a set of one or more computer-readable storage media and program instructions, collectively stored in the set of one or more computer readable storage media, for causing at least one computing device to perform computer operations. The computer operations include identifying, from an input specification of a circuit, a dual-edge pulse clock that is based on a source clock specified in the input specification. The dual-edge pulse clock includes leading-edge pulses triggered based on leading edges of the source clock and trailing-edge pulses triggered based on trailing edges of the source clock. The method also includes modeling the dual-edge pulse clock by a set of clock signals for a timing analysis of the circuit. The set of clock signals includes one clock signal that models the leading-edge pulses of the dual-edge pulse clock and another clock signal that models the trailing-edge pulses of the dual-edge pulse clock.

In further aspects, a computer-implemented method is provided that includes identifying, from an input specification of a circuit, a plurality of dual-edge pulse clocks based on a source clock specified in the input specification. Each dual-edge pulse clock of the identified plurality of dual-edge pulse clocks includes respective leading-edge pulses triggered based on leading edges of the source clock and trailing-edge pulses triggered based on trailing edges of the source clock. The identified plurality of dual-edge pulse clocks are of a setup test, of a timing analysis of the circuit, for testing mid-cycle edge uncertainty of the source clock in a multi-cycle path in which data provided from a latch of the circuit is to be flushed through one or more sequentially-next latches of the circuit and arrive at another latch of the circuit. The testing is based on an earliest mid-cycle edge arrival time of the source clock and a latest mid-cycle edge arrival time of the source clock. The method further includes modeling each dual-edge pulse clock of the identified plurality of dual-edge pulse clocks. The modeling models (i) a first dual-edge pulse clock of the identified plurality of dual-edge pulse clocks based on an early-arrival source clock, representing the earliest mid-cycle edge arrival time, using a respective set of clock signals, as early-arrival clock signals. The set of clock signals, as early-arrival clock signals, includes a first clock signal that models pulses, of the first dual-edge pulse clock, triggered based on leading edges of the early-arrival source clock. The set of clock signals, as early-arrival clock signals, further includes a second clock signal that models pulses, of the first dual-edge pulse clock, triggered based on trailing edges of the early-arrival source clock. The trailing edges of the early-arrival source clock are mid-cycle edges of the early-arrival source clock. The modeling also models (ii) a second dual-edge pulse clock of the identified plurality of dual-edge pulse clocks based on a late-arrival source clock, representing the latest mid-cycle edge arrival time, using a respective set of clock signals, as late-arrival clock signals. The set of clock signals, as late-arrival clock signals, includes a first clock signal that models pulses, of the second dual-edge pulse clock, triggered based on leading edges of the late-arrival source clock. The set of clock signals, as late-arrival clock signals, also includes a second clock signal that models pulses, of the second dual-edge pulse clock, triggered based on trailing edges of the late-arrival source clock. The trailing edges of the late-arrival source clock being mid-cycle edges of the late-arrival source clock. The method also includes performing the timing analysis based on the modeling. The timing analysis includes the setup test for testing mid-cycle edge uncertainty and pulse width testing. The pulse width testing determines pulse width of the respective leading-edge pulses of a selected dual-edge pulse clock, of the identified plurality of dual-edge pulse clocks, as a width of pulses of one clock signal that models the respective leading-edge pulses of the selected dual-edge pulse clock. The pulse width testing also determines pulse width of the respective trailing-edge pulses of the selected dual-edge pulse clock as a width of pulses of another clock signal that models the respective trailing-edge pulses of the selected dual-edge pulse clock.

In yet further aspects, a computer system is provided that includes at least one computing device, a set of one or more computer readable storage media, and program instructions, collectively stored in the set of one or more computer readable storage media, for causing the at least one computing device to perform computer operations. The computer operations include identifying, from an input specification of a circuit, a plurality of dual-edge pulse clocks based on a source clock specified in the input specification. Each dual-edge pulse clock of the identified plurality of dual-edge pulse clocks includes respective leading-edge pulses triggered based on leading edges of the source clock and trailing-edge pulses triggered based on trailing edges of the source clock. The identified plurality of dual-edge pulse clocks are of a setup test, of a timing analysis of the circuit, for testing mid-cycle edge uncertainty of the source clock in a multi-cycle path in which data provided from a latch of the circuit is to be flushed through one or more sequentially-next latches of the circuit and arrive at another latch of the circuit. The testing is based on an earliest mid-cycle edge arrival time of the source clock and a latest mid-cycle edge arrival time of the source clock. The computer operations further include modeling each dual-edge pulse clock of the identified plurality of dual-edge pulse clocks. The modeling models (i) a first dual-edge pulse clock of the identified plurality of dual-edge pulse clocks based on an early-arrival source clock, representing the earliest mid-cycle edge arrival time, using a respective set of clock signals, as early-arrival clock signals. The set of clock signals, as early-arrival clock signals, includes a first clock signal that models pulses, of the first dual-edge pulse clock, triggered based on leading edges of the early-arrival source clock. The set of clock signals, as early-arrival clock signals, further includes a second clock signal that models pulses, of the first dual-edge pulse clock, triggered based on trailing edges of the early-arrival source clock. The trailing edges of the early-arrival source clock are mid-cycle edges of the early-arrival source clock. The modeling also models (ii) a second dual-edge pulse clock of the identified plurality of dual-edge pulse clocks based on a late-arrival source clock, representing the latest mid-cycle edge arrival time, using a respective set of clock signals, as late-arrival clock signals. The set of clock signals, as late-arrival clock signals, includes a first clock signal that models pulses, of the second dual-edge pulse clock, triggered based on leading edges of the late-arrival source clock. The set of clock signals, as late-arrival clock signals, also includes a second clock signal that models pulses, of the second dual-edge pulse clock, triggered based on trailing edges of the late-arrival source clock. The trailing edges of the late-arrival source clock being mid-cycle edges of the late-arrival source clock. The computer operations also include performing the timing analysis based on the modeling. The timing analysis includes the setup test for testing mid-cycle edge uncertainty and pulse width testing. The pulse width testing determines pulse width of the respective leading-edge pulses of a selected dual-edge pulse clock, of the identified plurality of dual-edge pulse clocks, as a width of pulses of one clock signal that models the respective leading-edge pulses of the selected dual-edge pulse clock. The pulse width testing also determines pulse width of the respective trailing-edge pulses of the selected dual-edge pulse clock as a width of pulses of another clock signal that models the respective trailing-edge pulses of the selected dual-edge pulse clock.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts an example conceptual diagram of static timing analysis using a static timing analyzer;

FIG. 3 depicts an example clocking topology;

FIG. 4 depicts examples of single-edge and dual-edge timing signals based on an input signal;

FIG. 5 depicts example timing signals of single-edge pulse modeling by a timing tool;

FIG. 6 depicts example timing signals of dual-edge pulse modeling by a timing tool;

FIG. 7 conceptually depicts timing operation of a pulsed latch;

FIG. 8 depicts another example of timing signals of single-edge pulse modeling by a timing tool;

FIG. 9 depicts another example of timing signals of dual-edge pulse modeling by a timing tool;

FIG. 10 depicts an example conceptual diagram of dual-edge pulse clock modeling in accordance with aspects described herein;

FIG. 11 depicts example clock definitions of a pair of clocks for modeling a dual-edge timing signal, in accordance with aspects described herein;

FIG. 12 conceptually depicts the concept of mid-cycle edge uncertainty relative to an input clock signal;

FIG. 13 conceptually depicts an example modeling of mid-cycle edge uncertainty by a conventional timing analysis tool;

FIG. 14 conceptually illustrates data launch and capture in a single-cycle path for early and late mode mid-cycle edge arrival scenarios;

FIG. 15 conceptually illustrates data launch and capture in a two-cycle path for early and late mode mid-cycle edge arrival scenarios;

FIG. 16 conceptually illustrates an example of improper mid-cycle edge penalization;

FIGS. 17-18 conceptually depict an example approach for modeling mid-cycle edge arrival scenarios, in accordance with aspects described herein;

FIG. 19 depicts example clock definitions of a set of clocks for modeling two dual-edge timing signals, in accordance with aspects described herein;

FIG. 20 depicts an example process for setup of a dual-edge timing analysis in accordance with aspects described herein;

FIGS. 21-23 depict examples of shifting clock pulses triggered by a mid-cycle edge, in accordance with aspects described herein;

FIG. 24 depicts further details of an example circuit design testing code of FIG. 1 to incorporate and/or use aspects described herein; and

FIG. 25 depicts an example process for circuit design testing in accordance with aspects described herein.

### DETAILED DESCRIPTION

Described herein are approaches for timing analysis to be performed by a timing analyzer. Embodiments of approaches described herein can be particularly useful for timing analyses of dual-edge triggered pulsed latches, for instance analyses relating to pulse durations and scenarios of mid-cycle timing uncertainty, as described herein.

In one or more aspects, a computer-implemented method is provided that includes identifying, from an input specification of a circuit, a dual-edge pulse clock that is based on a source clock specified in the input specification. The dual-edge pulse clock includes leading-edge pulses triggered based on leading edges of the source clock and trailing-edge pulses triggered based on trailing edges of the source clock. The method also includes modeling the dual-edge pulse clock by a set of clock signals for a timing analysis of the circuit, the set of clock signals including one clock signal that models the leading-edge pulses of the dual-edge pulse clock and another clock signal that models the trailing-edge pulses of the dual-edge pulse clock. Modeling the leading-edge pulses and trailing-edge pulses separately has an advantage of enabling more accurate timing analyses, including those involving pulse width determination and mid-cycle arrival penalization.

Additionally, or alternatively, in one or more embodiments, the method further includes performing the timing analysis based on the modeling. The timing analysis includes pulse width testing. The pulse width testing determines pulse width of the leading-edge pulses of the dual-edge pulse clock as a width of pulses of the one clock signal, and determines pulse width of the trailing-edge pulses of the dual-edge pulse clock as a width of pulses of the another clock signal. Thus, the timing analysis determines pulse widths by looking at the pulse widths of the individual clock signals, which has an advantage of avoiding incorrect pulse width duration of conventional practices based on misinterpretations of the rising/falling edges of the dual-edge pulse clock.

Additionally, or alternatively, in one or more embodiments, the modeling includes defining each of the one clock signal and the another clock signal by a respective cycle time, leading edge time, and trailing edge time.

Additionally, or alternatively, in one or more embodiments, the modeling includes defining leading edges of the one clock signal to correspond to the leading edges of the source clock. The modeling further includes defining leading edges of the another clock signal to correspond to the trailing edges of the source clock. This has an advantage of enabling the two clocks to be propagated together to mimic the two pulses per cycle desired for dual-edge timing. This can facilitate, for instance, a clock rate step-up locally clocking at a higher rate than an input clock.

Additionally, or alternatively, in one or more embodiments, the dual-edge pulse clock is one clock of a setup test, of the timing analysis, for testing mid-cycle edge uncertainty of the source clock in a multi-cycle path in which data provided from a latch of the circuit is to be flushed through one or more sequentially-next latches of the circuit and arrive at another latch of the circuit, the testing being based on an earliest mid-cycle edge arrival time of the source clock and a latest mid-cycle edge arrival time of the source clock. Additionally, or alternatively, in one or more embodiments, the dual-edge pulse clock is one dual-edge pulse clock of a plurality of identified dual-edge pulse clocks. The method can model (i) a first dual-edge pulse clock of the plurality of identified dual-edge pulse clocks based on an early-arrival source clock, representing the earliest mid-cycle edge arrival time, using a respective set of clock signals, as early-arrival clock signals. The set of clock signals, as early-arrival clock signals, includes a first clock signal that models pulses, of the first dual-edge pulse clock, triggered based on leading edges of the early-arrival source clock. The set of clock signals, as early-arrival clock signals, also includes a second clock signal that models pulses, of the first dual-edge pulse clock, triggered based on trailing edges of the early-arrival source clock. The trailing edges of the early-arrival source clock are mid-cycle edges of the early-arrival source clock. The method can further model (ii) a second dual-edge pulse clock of the plurality of identified dual-edge pulse clocks based on a late-arrival source clock, representing the latest mid-cycle edge arrival time, using a respective set of clock signals, as late-arrival clock signals. The set of clock signals, as late-arrival clock signals, includes a first clock signal that models pulses, of the second dual-edge pulse clock, triggered based on leading edges of the late-arrival source clock. The set of clock signals, as late-arrival clock signals, further includes a second clock signal that models pulses, of the second dual-edge pulse clock, triggered based on trailing edges of the late-arrival source clock. The trailing edges of the late-arrival source clock are mid-cycle edges of the late-arrival source clock. Modeling the dual-edge pulse clocks in this manner has an advantage when modeling early and late-arrival mid-cycle edge arrival scenarios by facilitating proper assessment of arrival penalties to multi-cycle paths as explained herein. Additionally, or alternatively, in one or more embodiments, the first dual-edge pulse clock represents one of a first duty cycle waveform and a second duty cycle waveform. The second clock signal of the early-arrival clock signals includes pulses with leading edges corresponding to the earliest mid-cycle arrival time. The second dual-edge pulse clock represents another of the first duty cycle waveform and the second duty cycle waveform, and the second clock signal of the late-arrival clock signals includes pulses with leading edges corresponding to the latest mid-cycle edge arrival time.

Additionally, or alternatively, in one or more embodiments, the method further includes shifting the pulses of the second clock signal of the late-arrival clock signals earlier by a difference between the latest mid-cycle edge arrival time and the earliest mid-cycle edge arrival time. Alternatively, in one or more embodiments, the method further includes shifting the pulses of the second clock signal of the early-arrival clock signals later by a difference between the latest mid-cycle edge arrival time and the earliest mid-cycle edge arrival time.

Additionally, or alternatively, in one or more embodiments, the method further includes applying tags to the early-arrival clock signals and the late-arrival clock signals, and performing the timing analysis. The performing the timing analysis performs a single timing analysis run that uses both the early-arrival clock signals and the late-arrival clock signals and mutually excludes the early-arrival clock signals from the late-arrival clock signals based on the applied tags to avoid conflicts between the early-arrival clock signals and the late-arrival clock signals in the single timing analysis run. This has an advantage in that it enables a single timing analysis run to use both sets of clock signals while avoiding conflicts between them, advantageously mimicking the effect of performing two independent runs, and thus reducing resources consumed for the testing.

In accordance with one or more aspects, each of the embodiments is separable and optional from one another. Further, embodiments may be combined with one another.

In one or more aspects, a computer system is provided. The computer system includes, for instance, at least one computing device, a set of one or more computer readable storage media, and program instructions, collectively stored in the set of one or more computer readable storage media, for causing the at least one computing device to perform computer operations. The operations include identifying, from an input specification of a circuit, a dual-edge pulse clock that is based on a source clock specified in the input specification. The dual-edge pulse clock includes leading-edge pulses triggered based on leading edges of the source clock and trailing-edge pulses triggered based on trailing edges of the source clock. The computer operations further include modeling the dual-edge pulse clock by a set of clock signals for a timing analysis of the circuit, the set of clock signals including one clock signal that models the leading-edge pulses of the dual-edge pulse clock and another clock signal that models the trailing-edge pulses of the dual-edge pulse clock. Modeling the leading-edge pulses and trailing-edge pulses separately has an advantage of enabling more accurate timing analyses, including those involving pulse width determination and mid-cycle arrival penalization.

Additionally, or alternatively, in one or more embodiments, the computer operations further include performing the timing analysis based on the modeling. The timing analysis includes pulse width testing. The pulse width testing determines pulse width of the leading-edge pulses of the dual-edge pulse clock as a width of pulses of the one clock signal, and determines pulse width of the trailing-edge pulses of the dual-edge pulse clock as a width of pulses of the another clock signal. Thus, the timing analysis determines pulse widths by looking at the pulse widths of the individual clock signals, which has an advantage of avoiding incorrect pulse width duration of conventional practices based on misinterpretations of the rising/falling edges of the dual-edge pulse clock.

Additionally, or alternatively, in one or more embodiments, the modeling includes defining leading edges of the one clock signal to correspond to the leading edges of the source clock. The modeling further includes defining leading edges of the another clock signal to correspond to the trailing edges of the source clock. This has an advantage of enabling the two clocks to be propagated together to mimic the two pulses per cycle desired for dual-edge timing. This can facilitate, for instance, a clock rate step-up locally clocking at a higher rate than an input clock.

Additionally, or alternatively, in one or more embodiments, the dual-edge pulse clock is one clock of a setup test, of the timing analysis, for testing mid-cycle edge uncertainty of the source clock in a multi-cycle path in which data provided from a latch of the circuit is to be flushed through one or more sequentially-next latches of the circuit and arrive at another latch of the circuit, the testing being based on an earliest mid-cycle edge arrival time of the source clock and a latest mid-cycle edge arrival time of the source clock. The dual-edge pulse clock is one dual-edge pulse clock of a plurality of identified dual-edge pulse clocks. The computer operations model (i) a first dual-edge pulse clock of the plurality of identified dual-edge pulse clocks based on an early-arrival source clock, representing the earliest mid-cycle edge arrival time, using a respective set of clock signals, as early-arrival clock signals. The set of clock signals, as early-arrival clock signals, includes a first clock signal that models pulses, of the first dual-edge pulse clock, triggered based on leading edges of the early-arrival source clock. The set of clock signals, as early-arrival clock signals, further includes a second clock signal that models pulses, of the first dual-edge pulse clock, triggered based on trailing edges of the early-arrival source clock. The trailing edges of the early-arrival source clock are mid-cycle edges of the early-arrival source clock. The computer operations further model (ii) a second dual-edge pulse clock of the plurality of identified dual-edge pulse clocks based on a late-arrival source clock, representing the latest mid-cycle edge arrival time, using a respective set of clock signals, as late-arrival clock signals. The set of clock signals, as late-arrival clock signals, includes a first clock signal that models pulses, of the second dual-edge pulse clock, triggered based on leading edges of the late-arrival source clock. The set of clock signals, as late-arrival clock signals, further includes a second clock signal that models pulses, of the second dual-edge pulse clock, triggered based on trailing edges of the late-arrival source clock. The trailing edges of the late-arrival source clock are mid-cycle edges of the late-arrival source clock. Modeling the dual-edge pulse clocks in this manner has an advantage when modeling early and late-arrival mid-cycle edge arrival scenarios by facilitating proper assessment of arrival penalties to multi-cycle paths as explained herein. Additionally, or alternatively, in one or more embodiments, the first dual-edge pulse clock represents one of a first duty cycle waveform and a second duty cycle waveform. The second clock signal of the early-arrival clock signals includes pulses with leading edges corresponding to the earliest mid-cycle arrival time. The second dual-edge pulse clock represents another of the first duty cycle waveform and the second duty cycle waveform, and the second clock signal of the late-arrival clock signals includes pulses with leading edges corresponding to the latest mid-cycle edge arrival time.

Additionally, or alternatively, in one or more embodiments, the computer operations further include shifting the pulses of the second clock signal of the late-arrival clock signals earlier by a difference between the latest mid-cycle edge arrival time and the earliest mid-cycle edge arrival time, or shifting the pulses of the second clock signal of the early-arrival clock signals later by a difference between the latest mid-cycle edge arrival time and the earliest mid-cycle edge arrival time.

Additionally, or alternatively, in one or more embodiments, the computer operations further include applying tags to the early-arrival clock signals and the late-arrival clock signals, and performing the timing analysis. Performing the timing analysis performs a single timing analysis run that uses both the early-arrival clock signals and the late-arrival clock signals and mutually excludes the early-arrival clock signals from the late-arrival clock signals based on the applied tags to avoid conflicts between the early-arrival clock signals and the late-arrival clock signals in the single timing analysis run. This has an advantage in that it enables a single timing analysis run to use both sets of clock signals while avoiding conflicts between them, advantageously mimicking the effect of performing two independent runs, and thus reducing resources consumed for the testing.

In accordance with one or more aspects, each of the embodiments is separable and optional from one another. Further, embodiments may be combined with one another.

In one or more aspects, a computer program product is provided. The computer program product includes, for instance, a set of one or more computer readable storage media and program instructions, collectively stored in the set of one or more computer readable storage media, for causing at least one computing device to perform computer operations. The computer operations include identifying, from an input specification of a circuit, a dual-edge pulse clock that is based on a source clock specified in the input specification. The dual-edge pulse clock includes leading-edge pulses triggered based on leading edges of the source clock and trailing-edge pulses triggered based on trailing edges of the source clock. The computer operations further include modeling the dual-edge pulse clock by a set of clock signals for a timing analysis of the circuit. The set of clock signals include one clock signal that models the leading-edge pulses of the dual-edge pulse clock and another clock signal that models the trailing-edge pulses of the dual-edge pulse clock. Modeling the leading-edge pulses and trailing-edge pulses separately has an advantage of enabling more accurate timing analyses, including those involving pulse width determination and mid-cycle arrival penalization.

Additionally, or alternatively, in one or more embodiments, the computer operations further include performing the timing analysis based on the modeling. The timing analysis includes pulse width testing. The pulse width testing determines pulse width of the leading-edge pulses of the dual-edge pulse clock as a width of pulses of the one clock signal, and determines pulse width of the trailing-edge pulses of the dual-edge pulse clock as a width of pulses of the another clock signal. Thus, the timing analysis determines pulse widths by looking at the pulse widths of the individual clock signals, which has an advantage of avoiding incorrect pulse width duration of conventional practices based on misinterpretations of the rising/falling edges of the dual-edge pulse clock.

Additionally, or alternatively, in one or more embodiments the modeling includes defining leading edges of the one clock signal to correspond to the leading edges of the source clock. The modeling further includes defining leading edges of the another clock signal to correspond to the trailing edges of the source clock. This has an advantage of enabling the two clocks to be propagated together to mimic the two pulses per cycle desired for dual-edge timing. This can facilitate, for instance, a clock rate step-up locally clocking at a higher rate than an input clock.

Additionally, or alternatively, in one or more embodiments the dual-edge pulse clock is one clock of a setup test, of the timing analysis, for testing mid-cycle edge uncertainty of the source clock in a multi-cycle path in which data provided from a latch of the circuit is to be flushed through one or more sequentially-next latches of the circuit and arrive at another latch of the circuit, the testing being based on an earliest mid-cycle edge arrival time of the source clock and a latest mid-cycle edge arrival time of the source clock. The dual-edge pulse clock is one dual-edge pulse clock of a plurality of identified dual-edge pulse clocks. The computer operations model (i) a first dual-edge pulse clock of the plurality of identified dual-edge pulse clocks based on an early-arrival source clock, representing the earliest mid-cycle edge arrival time, using a respective set of clock signals, as early-arrival clock signals. The set of clock signals, as early-arrival clock signals, includes a first clock signal that models pulses, of the first dual-edge pulse clock, triggered based on leading edges of the early-arrival source clock. The set of clock signals, as early-arrival clock signals, further includes a second clock signal that models pulses, of the first dual-edge pulse clock, triggered based on trailing edges of the early-arrival source clock. The trailing edges of the early-arrival source clock are mid-cycle edges of the early-arrival source clock. The computer operations further model (ii) a second dual-edge pulse clock of the plurality of identified dual-edge pulse clocks based on a late-arrival source clock, representing the latest mid-cycle edge arrival time, using a respective set of clock signals, as late-arrival clock signals. The set of clock signals, as late-arrival clock signals, includes a first clock signal that models pulses, of the second dual-edge pulse clock, triggered based on leading edges of the late-arrival source clock. The set of clock signals, as late-arrival clock signals, further includes a second clock signal that models pulses, of the second dual-edge pulse clock, triggered based on trailing edges of the late-arrival source clock. The trailing edges of the late-arrival source clock are mid-cycle edges of the late-arrival source clock. Modeling the dual-edge pulse clocks in this manner has an advantage when modeling early and late-arrival mid-cycle edge arrival scenarios by facilitating proper assessment of arrival penalties to multi-cycle paths as explained herein. Additionally, or alternatively, in one or more embodiments, the first dual-edge pulse clock represents one of a first duty cycle waveform and a second duty cycle waveform. The second clock signal of the early-arrival clock signals includes pulses with leading edges corresponding to the earliest mid-cycle arrival time. The second dual-edge pulse clock represents another of the first duty cycle waveform and the second duty cycle waveform, and the second clock signal of the late-arrival clock signals includes pulses with leading edges corresponding to the latest mid-cycle edge arrival time.

Additionally, or alternatively, in one or more embodiments 23. The computer program product of claim 22, wherein the computer operations further include shifting the pulses of the second clock signal of the late-arrival clock signals earlier by a difference between the latest mid-cycle edge arrival time and the earliest mid-cycle edge arrival time, or shifting the pulses of the second clock signal of the early-arrival clock signals later by a difference between the latest mid-cycle edge arrival time and the earliest mid-cycle edge arrival time.

In accordance with one or more aspects, each of the embodiments is separable and optional from one another. Further, embodiments may be combined with one another.

In one or more aspects, a computer-implemented method is provided. The method includes, for instance, identifying, from an input specification of a circuit, a plurality of dual-edge pulse clocks based on a source clock specified in the input specification. Each dual-edge pulse clock of the identified plurality of dual-edge pulse clocks includes respective leading-edge pulses triggered based on leading edges of the source clock and trailing-edge pulses triggered based on trailing edges of the source clock. The identified plurality of dual-edge pulse clocks are of a setup test, of a timing analysis of the circuit, for testing mid-cycle edge uncertainty of the source clock in a multi-cycle path in which data provided from a latch of the circuit is to be flushed through one or more sequentially-next latches of the circuit and arrive at another latch of the circuit. The testing is based on an earliest mid-cycle edge arrival time of the source clock and a latest mid-cycle edge arrival time of the source clock. The method further includes modeling each dual-edge pulse clock of the identified plurality of dual-edge pulse clocks. The modeling models (i) a first dual-edge pulse clock of the identified plurality of dual-edge pulse clocks based on an early-arrival source clock, representing the earliest mid-cycle edge arrival time, using a respective set of clock signals, as early-arrival clock signals. The set of clock signals, as early-arrival clock signals, includes a first clock signal that models pulses, of the first dual-edge pulse clock, triggered based on leading edges of the early-arrival source clock. The set of clock signals, as early-arrival clock signals, further includes a second clock signal that models pulses, of the first dual-edge pulse clock, triggered based on trailing edges of the early-arrival source clock. The trailing edges of the early-arrival source clock are mid-cycle edges of the early-arrival source clock. The modeling further models (ii) a second dual-edge pulse clock of the identified plurality of dual-edge pulse clocks based on a late-arrival source clock, representing the latest mid-cycle edge arrival time, using a respective set of clock signals, as late-arrival clock signals. The set of clock signals, as late-arrival clock signals, includes a first clock signal that models pulses, of the second dual-edge pulse clock, triggered based on leading edges of the late-arrival source clock. The set of clock signals, as late-arrival clock signals, further includes a second clock signal that models pulses, of the second dual-edge pulse clock, triggered based on trailing edges of the late-arrival source clock. The trailing edges of the late-arrival source clock are mid-cycle edges of the late-arrival source clock. The method further includes performing the timing analysis based on the modeling. The timing analysis includes the setup test for testing mid-cycle edge uncertainty and pulse width testing. The pulse width testing determines pulse width of the respective leading-edge pulses of a selected dual-edge pulse clock, of the identified plurality of dual-edge pulse clocks, as a width of pulses of one clock signal that models the respective leading-edge pulses of the selected dual-edge pulse clock. The pulse width testing further determines pulse width of the respective trailing-edge pulses of the selected dual-edge pulse clock as a width of pulses of another clock signal that models the respective trailing-edge pulses of the selected dual-edge pulse clock. Modeling leading-edge pulses and trailing-edge pulses separately has an advantage of enabling more accurate timing analyses, including those involving pulse width determination and mid-cycle arrival penalization. Further, modeling the first and second dual-edge pulse clocks in this manner has an advantage when modeling early and late-arrival mid-cycle edge arrival scenarios by facilitating proper assessment of arrival penalties to multi-cycle paths as explained herein. Yet further, timing analysis determining pulse widths by looking at the pulse widths of the individual clock signals has an advantage of avoiding incorrect pulse width duration of conventional practices based on misinterpretations of the rising/falling edges of the dual-edge pulse clock. The above-recited aspects provide improvements in both pulse width determination and mid-cycle arrival penalization.

In one or more aspects, a computer system is provided. The computer system includes, for instance at least one computing device, a set of one or more computer readable storage media, and program instructions, collectively stored in the set of one or more computer readable storage media, for causing the at least one computing device to perform computer operations. The computer operations include identifying, from an input specification of a circuit, a plurality of dual-edge pulse clocks based on a source clock specified in the input specification. Each dual-edge pulse clock of the identified plurality of dual-edge pulse clocks includes respective leading-edge pulses triggered based on leading edges of the source clock and trailing-edge pulses triggered based on trailing edges of the source clock. The identified plurality of dual-edge pulse clocks are of a setup test, of a timing analysis of the circuit, for testing mid-cycle edge uncertainty of the source clock in a multi-cycle path in which data provided from a latch of the circuit is to be flushed through one or more sequentially-next latches of the circuit and arrive at another latch of the circuit. The testing is based on an earliest mid-cycle edge arrival time of the source clock and a latest mid-cycle edge arrival time of the source clock. The computer operations further include modeling each dual-edge pulse clock of the identified plurality of dual-edge pulse clocks. The modeling models (i) a first dual-edge pulse clock of the identified plurality of dual-edge pulse clocks based on an early-arrival source clock, representing the earliest mid-cycle edge arrival time, using a respective set of clock signals, as early-arrival clock signals. The set of clock signals, as early-arrival clock signals, includes a first clock signal that models pulses, of the first dual-edge pulse clock, triggered based on leading edges of the early-arrival source clock. The set of clock signals, as early-arrival clock signals, further includes a second clock signal that models pulses, of the first dual-edge pulse clock, triggered based on trailing edges of the early-arrival source clock. The trailing edges of the early-arrival source clock are mid-cycle edges of the early-arrival source clock. The modeling further models (ii) a second dual-edge pulse clock of the identified plurality of dual-edge pulse clocks based on a late-arrival source clock, representing the latest mid-cycle edge arrival time, using a respective set of clock signals, as late-arrival clock signals. The set of clock signals, as late-arrival clock signals, includes a first clock signal that models pulses, of the second dual-edge pulse clock, triggered based on leading edges of the late-arrival source clock. The set of clock signals, as late-arrival clock signals, further includes a second clock signal that models pulses, of the second dual-edge pulse clock, triggered based on trailing edges of the late-arrival source clock. The trailing edges of the late-arrival source clock are mid-cycle edges of the late-arrival source clock. The computer operations further include performing the timing analysis based on the modeling. The timing analysis includes the setup test for testing mid-cycle edge uncertainty and pulse width testing. The pulse width testing determines pulse width of the respective leading-edge pulses of a selected dual-edge pulse clock, of the identified plurality of dual-edge pulse clocks, as a width of pulses of one clock signal that models the respective leading-edge pulses of the selected dual-edge pulse clock. The pulse width testing further determines pulse width of the respective trailing-edge pulses of the selected dual-edge pulse clock as a width of pulses of another clock signal that models the respective trailing-edge pulses of the selected dual-edge pulse clock. Modeling leading-edge pulses and trailing-edge pulses separately has an advantage of enabling more accurate timing analyses, including those involving pulse width determination and mid-cycle arrival penalization. Further, modeling the first and second dual-edge pulse clocks in this manner has an advantage when modeling early and late-arrival mid-cycle edge arrival scenarios by facilitating proper assessment of arrival penalties to multi-cycle paths as explained herein. Yet further, timing analysis determining pulse widths by looking at the pulse widths of the individual clock signals has an advantage of avoiding incorrect pulse width duration of conventional practices based on misinterpretations of the rising/falling edges of the dual-edge pulse clock. The above-recited aspects provide improvements in both pulse width determination and mid-cycle arrival penalization.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, services relating to one or more aspects are also described and may be claimed herein. Further, it is noted that advantages described or set-forth explicitly or implicitly herein may not be present in all embodiments described herein, and are not necessarily required of all embodiments described herein.

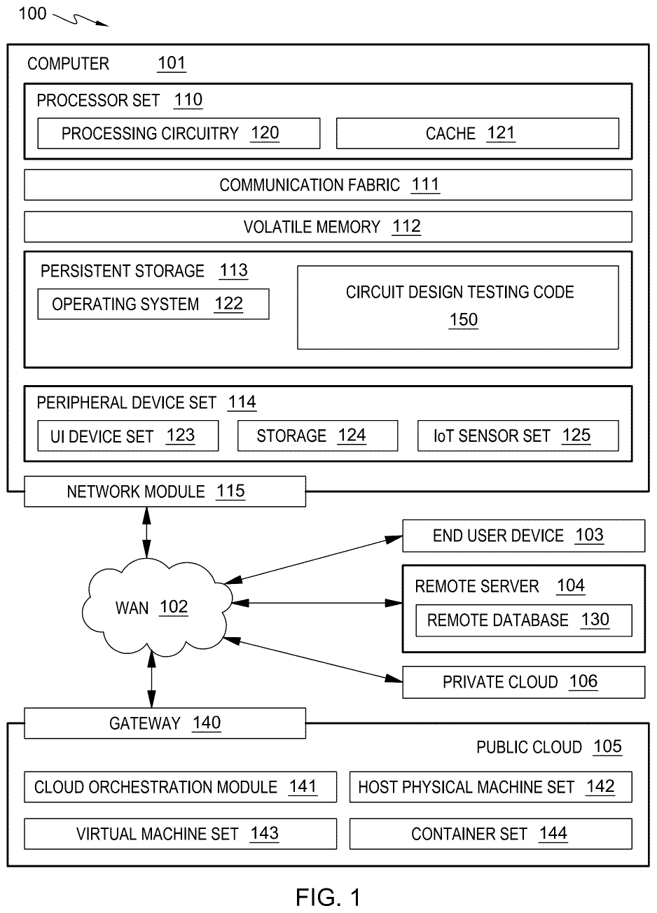

One or more embodiments described herein may be incorporated in, performed by and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as circuit design testing code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication Fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral Device Set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network Module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote Server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public Cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud Computing Services and/or Microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above in FIG. 1 is only one example of a computing environment to incorporate, perform, and/or use aspect(s) of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

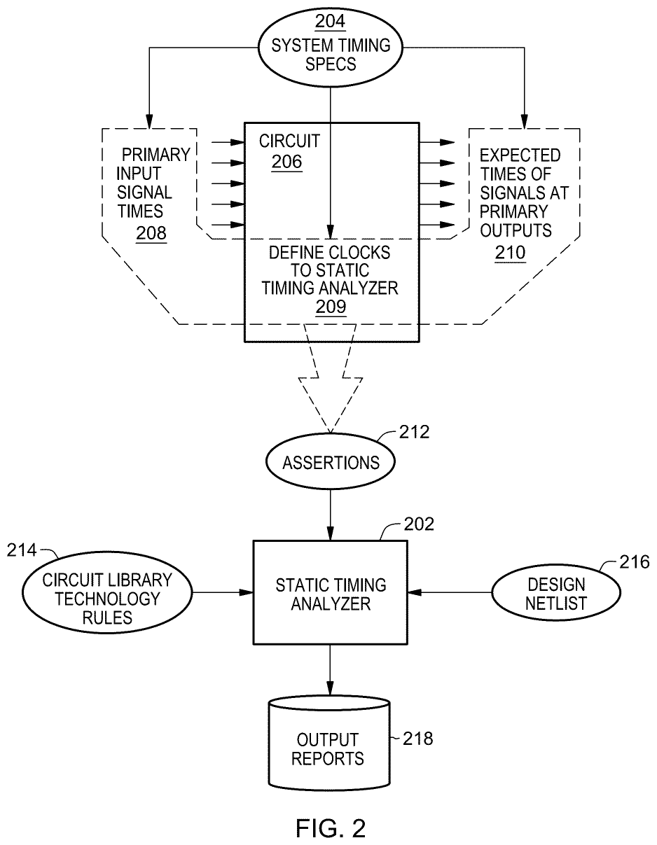

FIG. 2 depicts an example conceptual diagram of static timing analysis using a static timing analyzer. A static timing analyzer 202, for instance one implemented in software executing on hardware computer system(s), receives various inputs for performing the timing analysis and any other desired testing. These inputs are broadly referred to herein as an input specification of a circuit.

Assertions 212 are one type of input to the static timing analyzer 202. The assertions 212 are determined based on various system timing specifications 204 that are provided. The system timing specifications 204 provide various timing constraints surrounding the timing of the circuit and components thereof, and are independent of the design netlist 216. Using 206 as symbolic of the circuit for testing, the timing specifications 204 specify primary input signal times 208 (i.e., signal times at the primary inputs of the circuit 206), define the circuit clocks 209 to the timing analyzer 202, and specify primary output signal times 210 (i.e., expected times of signals at the primary outputs of the circuit 206). The signal times 208 and 210 are input and output boundary conditions for the circuit being simulated. A clock definition of a clock might include, as an example, the overall clock period for the clock and the edge times (times of rising, falling edges) of the clock. Additionally, timing windows are propagated which indicate transition/stabilization timing during the active clock cycles and inform arrival times for the primary input/output signals.

The system timing specifications are provided as assertions 212 to the static timing analyzer 202. Another input to the timing analyzer 202 is the design netlist 216, which describes the circuit components and connections therebetween. Yet another input to the timing analyzer 202 is circuit library technology rules 214, also referred to herein as pre-characterized timing rules. These rules specify device-specific timing characteristics, such as the delay of a signal through a circuit component/device such as an inverter. Other inputs to the static timing analyzer 202 are possible, for instance inputs surrounding particular tests (timing or otherwise) to be performed.

The static timing analyzer 202 performs static timing analysis/analyses based on these inputs, and generates output reports 218 with results of the analysis. In examples, the reports 218 indicate measurements of how closely the design meets timing requirements and identify paths through the circuit that do not meet timing specifications.

In accordance with some aspects described herein, approaches are provided for defining clocks that create constraints to facilitate timing analysis, particularly timing analysis of dual-edge triggered pulse latches. It is noted that aspects described herein can apply to various types of timing analyses. Examples include gate level timing and transistor level timing, referring to analysis of a circuit's timing characteristics at the level of individual logic gates or transistors, respectively. Additionally or alternatively, aspects described herein can be applied for timing analysis/analyses that include multiple clocks that have different cycle times. Further, aspects described herein can be used in embodiments of data flow through pulsed latches, transparent latches, or a combination of the two.

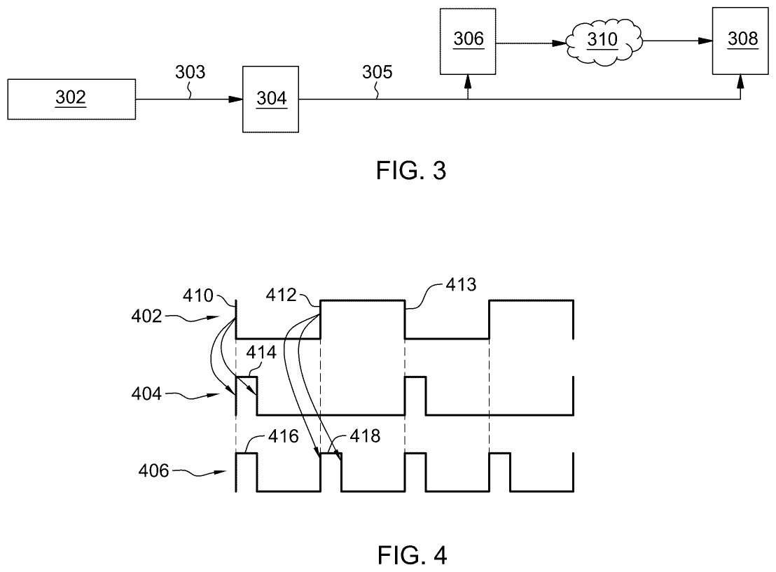

Initially, an example clocking topology is depicted by FIG. 3. An input clock (or ‘source clock’) 303 is generated by clock source 302 and is input to a pulse generator 304. The pulse generator 304 generates a pulse clock 305 (also referred to as an output clock), which is a sequence of typically relatively short pulses, each generated based on a single edge of the source clock, and each having a rising edge from a low state to a high state, followed by a stable region in the high state, followed by a falling edge back down to the low state. The width of the stable region in the high state is referred to as the pulse width.

In circuits, a latch that is clocked by a pulse clock is called a pulsed latch. In FIG. 3, two pulsed latches 306 and 308 are shown, and are both clocked by the pulse clock 305. The output of latch 306 is fed as input to other circuitry 310, which has output(s) to latch 308.

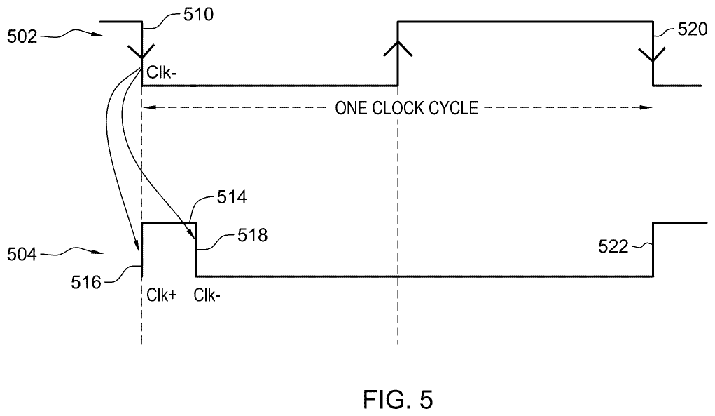

Example circuit timing schemes are single edge timing and dual edge timing. FIG. 4 depicts examples of single-edge and dual-edge timing signals based on an input signal. Shown in FIG. 4 are three timing signals. Timing signals presented in the figures discussed herein are presented as square waves that vary over time between low and high states. Progression of a signal from left to right corresponds to passage of time. Dashed vertical lines in the figures indicate a given point in time, and are usually used to indicate the timing of cycle endpoints or edges and illustrate relations between timing signals in terms of the occurrences of state transitions. It should be appreciated that the signals shown in FIG. 4 and many others elsewhere depict only one or two cycles of the signal and correlate to only a relatively small duration of time. In practice, the timing signals could continue repeating for a larger duration of time covering billions cycles.

Signal 402 is the input clock signal. The portion of the signal shown begins with a falling edge 410 at which the signal transitions from the high state to the low state. Falling edge 410 is followed later by a rising edge 412 from the low state to the high state. The signal remains in the high state until falling again at falling edge 413. A full cycle of the input clock in this example extends from edge 410 to edge 413. A duty cycle refers to the percentage of the ratio of pulse duration, or pulse width (PW), to the total period of the waveform. Regarding a pulse to be the signal in the high state, the duty cycle in this example is 50%, meaning the signal stays in the high state for 50% of the cycle, and therefore the low state also for 50%.

Signal 404 represents a single edge timing signal. In single edge timing, a single pulse is generated per cycle of the input clock, and thus latches clocked using the single-edge timing signal switch once per input clock cycle. This is illustrated by signal 404, which has a single pulse per cycle (e.g., pulse 414 in the first cycle generated based on the transition from high to low at edge 410). A pulse of signal 404 repeats at the time of edge 413 which begins the next cycle of the input clock. As noted, signals 402 and 404 would repeat in this fashion for a much longer duration of time (e.g., until power is removed from the circuit).

In dual-edge timing, pulses are generated on both the rising and the falling edges of the input clock. Thus, two pulses are generated per cycle of the input clock, and latches clocked using the dual-edge timing signal switch twice per input clock cycle. This is illustrated by signal 406, which has one pulse 416 generated based on the transition from high to low at edge 410 of the input clock and another pulse 418 generated based on the transition from low to high at edge 412 of the input clock, both in the first cycle of the input clock 402. A main difference between dual-edge timing and single-edge timing is that the pulse generator generates one pulse for each falling edge and another pulse for each rising edge of input clock signal, and thus two pulses per input clock cycle.

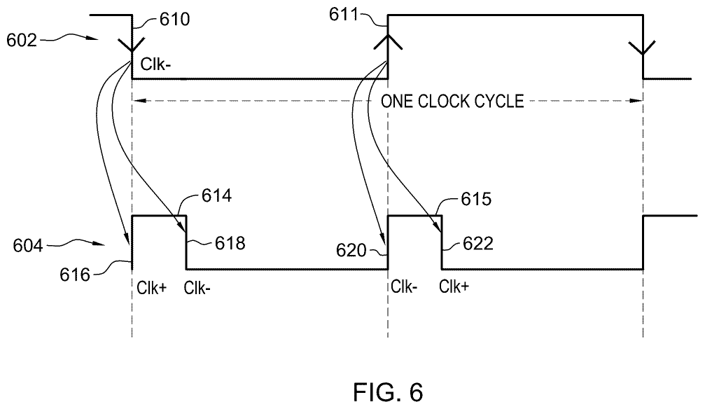

FIG. 5 depicts example timing signals of single-edge pulse modeling by a timing tool. FIG. 5 shows input clock signal 502 corresponding to the input clock, which is input for a pulse generator, and timing signal 504 corresponding to the pulse clock generated by the pulse generator based on the input clock. Here, the input clock may be denoted ‘Clk−’ to indicate that the falling edge, which is a transition from the high state of the signal to the low state of the signal, occurs before the rising edge in the clock cycle, the rising edge being a transition from the low state to the high state. Another way of saying this is that the falling edge is the ‘leading’ edge of each cycle, and the rising edge is the trailing edge of each cycle. An alternative to a Clk− is a Clk+, referring to a cycle in which the rising edge occurs before the falling edge, and thus the rising edge is the leading edge and the falling edge is the trailing edge.

As noted above, a single pulse is generated per clock cycle of the input clock. In this example, falling edge 510 of the input clock signal 502 triggers the pulse generator to generate pulse 514 having a rising edge 516 and a falling edge 518. This is the only pulse generated during the clock cycle beginning at edge 510. Edge 520 of the input clock signal is also a falling edge, indicate the start of the next input clock cycle, and triggers another pulse, hence the rising edge 522 of signal 504.

FIG. 5 conceptually depicts how a timing tool models a pulse based on pulse attributes in the input specification, for instance in a .lib file for a single edge pulse generator. For additional context, a negative unate timing sense implies an inverting timing arc—a falling input clock signal of a Clk− clock causes a transition from low to high in a Clk+ clock. A positive unate timing sense implies a non-inverting timing arc—a falling input clock signal of a Clk− clock causes a transition from high to low in a Clk− clock.

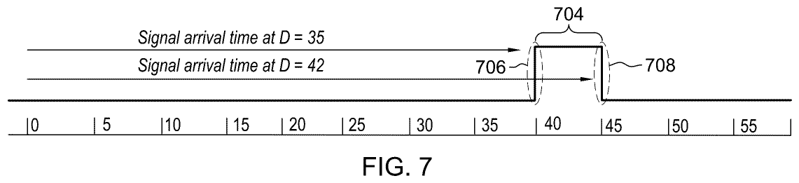

FIG. 6 depicts example timing signals of dual-edge pulse modeling by a timing tool. FIG. 6 includes input clock signal 602 corresponding to the input clock, which is input for a pulse generator, and timing signal 604 corresponding to the pulse clock generated by the pulse generated based on the input clock. Here, the input clock is again a ‘Clk−’, meaning the falling edge is the leading edge of the cycle and the rising edge is the trailing edge of the cycle.

In this example, falling edge 610 (the leading edge) of the input clock signal 602 triggers the pulse generator to generate pulse 614 of signal 604 having rising edge 616 and a falling edge 618, while rising edge 611 of the input clock signal 602 triggers the pulse generator to generate pulse 615 of signal 604 having rising edge 620 and a falling edge 622. Thus, for each edge of the input clock, a respective pulse of the pulse clock is produced. This produces a dual-edge pulse clock with two pulses in a single input clock cycle.

Dual-edge pulse clocks are often used to step-up clock speeds. The power consumed in a clock distribution network on the circuit is a strong function of the master clock frequency; the greater the number of times a clock is to switch per unit of time, the greater the power dissipation is for the clock network. Dual-edge timing enables the input clock to have a certain rate, say 2.5 gigahertz (GHz), while a local clock buffer, as a local circuit to service a subset of circuit components, can step-up frequency by doubling the clock pulses to effectively double the clock rate (to 5 GHz in this example). This allows the master clock to run at a rate that is slower than the clock rate for some sub-circuits, thus saving resources including power the resulting cost thereof.

A conventional timing tool will model the pulses generated by a dual-edge pulse generator, i.e., the pulses of signal 604. Specifically, both edges of the first pulse 614, generated from the leading edge of the input clock, will be modeled themselves as leading edges—one rising and one falling. Meanwhile, both edges of the second pulse 615, generated from the trailing edge of the input clock, will be modeled as trailing edges—specifically a trailing edge 620 corresponding to leading edge 618 and trailing edge 622 corresponding to leading edge 616.

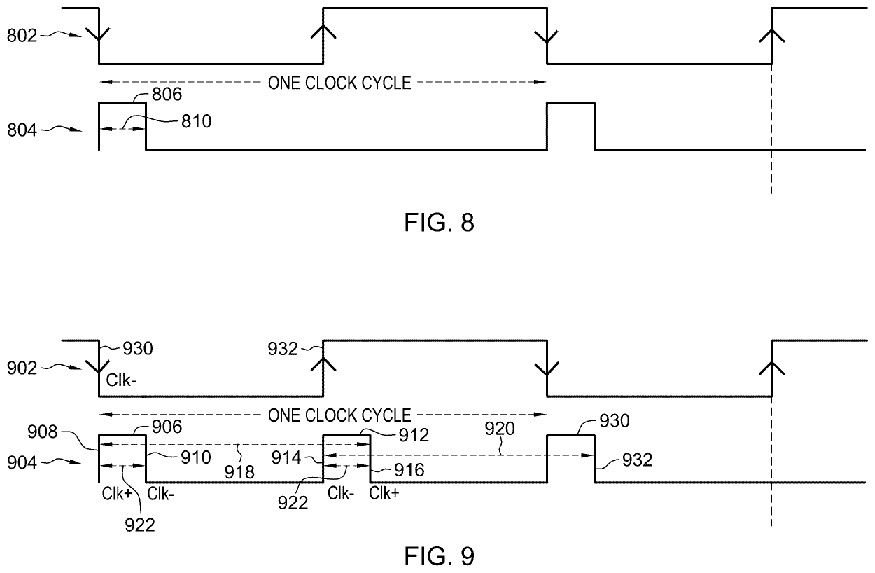

To help describe problems that can arise from this conventional modeling, consider a pulsed latch with a data (D) input, a clock (CK) input, and an output (Q). Timing operation of a pulsed latch is conceptually depicted by FIG. 7. The pulsed latch is level-sensitive during the active region of the clock pulse applied at input CK. This means that the output signal from Q would occur only during the active region (during the pulse) of the applied clock. In operation, whatever data is at the data input D will be latched (stored) and be reflected at the output only during a pulse. An important characteristic of a pulsed latch is that if the data arrives before the active region of the clock occurs, the output will be launched from the leading edge of the clock (which is rising here). Referring to FIG. 7 showing a timeline and a signal with a pulse (active region) from time 40 to 45, if data arrives at time 35, the output will change at 40, whereas if data arrives during the active region, say at time 42, then the output will change right away (assuming a zero delay between the D pin and Q pin of the latch). This level-sensitive behavior allows for time borrowing; the latch exhibits a transparent time frame during the active region, which can come into play if there are a series of pulsed latches. This allows ‘time borrowing’ in which data launched at the start of a clock cycle might be flushed through a latch and arrive at a downstream component by the start of the next clock cycle.

In FIG. 7, the lead edge 706 of the pulse 704 is the launching edge of the clock. Data is captured by the trailing edge 708 of the pulse, meaning ‘setup and hold’ tests may be defined against the trailing edge.

A ‘late mode arrival time’ of data out of output Q is the latest time as between data propagated from input D and the data being launched by the clock (active region thereof) at input CK. Assuming all propagation delays are zero, then if signal (data) arrival time at D is 35, then the signal arrival time at Q is when the clock is launched. If instead signal (data) arrival time at D is 42, then the data is flushed because it arrives during the active region, i.e., pulse 704.

Problems arise from the above. For instance, conventional timing analysis tools cannot identify dual-edge pulses automatically, which leads to incorrect minimum pulse width testing. To address this, aspects described herein model the pulses of a dual-edge pulse clock using two different clocks, which ensures that the timing tool correctly sees two pulses per clock cycle. This addresses incorrect minimum pulse width testing, further details of which are provided below. Conventionally, a static timing analysis tool would not model a dual-edge pulse clock using two separate clocks.

Further, conventional timing analysis tools modeling dual-edge timing use both cycle start (leading) edge and the mid-cycle (trailing) edge of the clock equally. However, uncertainty associated with mid-cycle edge timing consumes the timing budget of latch-to-latch paths. Existing methods of modeling mid-cycle edge uncertainty are pessimistic, as they double-penalize two-cycle paths in situations when there should be no penalty. Aspects described herein use four clocks to model mid-cycle uncertainty, which can overcome this issue of double-penalizing in two (or more generally any even number of) latches in a multi-cycle path.

Proper operation of a pulsed latch requires that the clock pulse be active for a minimum amount of time. This is referred to as a ‘minimum pulse width’ as pulse width directly correlates to an amount of time. Timing analysis can test that the minimum pulse width is provided to ensure proper latch behavior. Typically, minimum pulse width should be less than or equal to the minimum trailing edge network latency minus the maximum leading edge network latency.

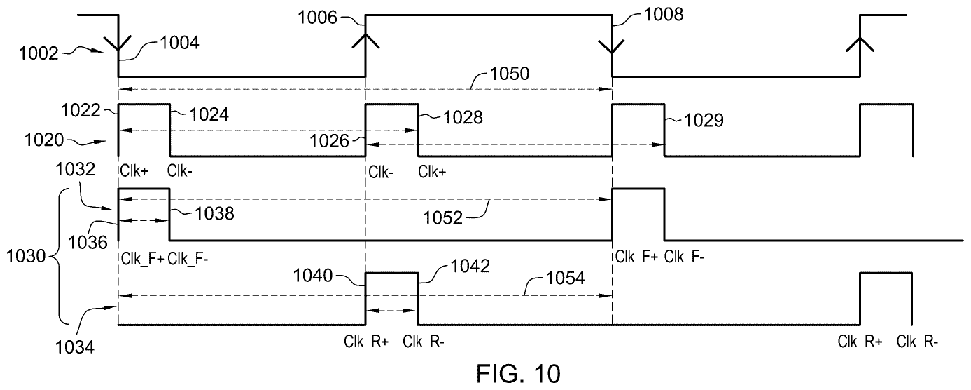

FIG. 8 depicts another example of timing signals of single-edge pulse modeling by a timing tool, similar to FIG. 5. In FIG. 8, the input clock signal is given by 802 and the single-edge pulse clock signal is given by 804. As noted, there is one pulse (e.g., pulse 806) in signal 804 per cycle of the input clock 802. The pulse is a ‘high’ pulse in this example, meaning it is defined by a rising edge at the beginning of the pulse. The pulse width for minimum pulse width testing is taken as the minimum falling edge network latency minus the maximum rising edge network latency.

In this example, the pulse clock has one rising edge and one falling edge per cycle, and therefore the pulse width computed by the timing tool (and as is expected) is accurately reflected by the span labeled 810.

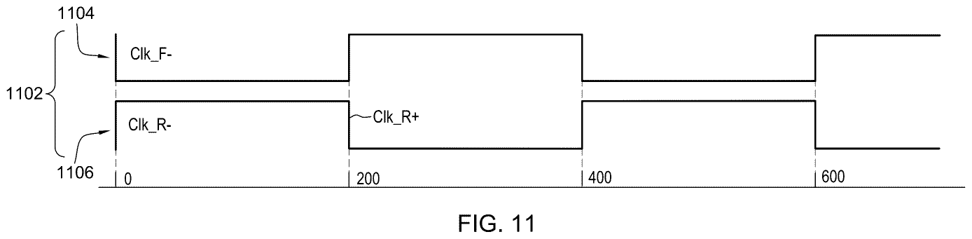

A problem arises in the dual-edge scenario. As described above with reference to FIG. 6, a conventional timing analysis tool would model both edges of the first pulse as leading edges and both edges of the second pulse as trailing edges that correspond to those leading edges, which is problematic. Referring to FIG. 9, showing another example of timing signals of dual-edge pulse modeling by a timing tool, shown are input clock signal 902 and dual-edge pulse clock signal 904, where signal 904 has two pulses 906 and 912 corresponding to the leading (falling) and trailing (rising) edges 930 and 932, respectively, of signal 902. The dual-edge pulse clock signal 904 has two rising and two falling edges per input cycle. Specifically, pulse 906 has rising edge 908 (indicating a Clk+ with negative unate timing relative to edge 930) and falling edge 910 (indicating a Clk− with positive unate timing relative to edge 930), which the timing tool treats as leading edges of two clock signals. Pulse 912 has rising edge 914 and falling edge 916, which the timing tool treats as trailing edges of the two clock signals. From this construction, the timing tool will determine a first pulse width 918 spanning from edge 908 (leading/rising edge of the first clock denoted Clk+) to edge 916 (trailing/falling edge of Clk+ and thusly labeled), and a second pulse width 920 spanning from edge 914 to edge 932 (the trailing and leading edges of the second clock denoted Clk−) of pulse 930. Both of these are incorrect computations. The correct computation of pulse width is from a rising edge to a subsequent falling edge (denoted by span 922).

Thus, in accordance with aspects described herein, a process identifies, from an input specification of a circuit, a dual-edge pulse clock that is based on a source clock specified in the input specification. The dual-edge pulse clock includes (i) leading-edge pulses, which are those triggered based on leading edges of the source clock, and (ii) trailing-edge pulses, which are those triggered based on trailing edges of the source clock. The process models this dual-edge pulse clock by a set of clock signals for a timing analysis of the circuit. The set of clock signals includes one clock signal that models the leading-edge pulses of the dual-edge pulse clock and another clock signal that models the trailing-edge pulses of the dual-edge pulse clock.

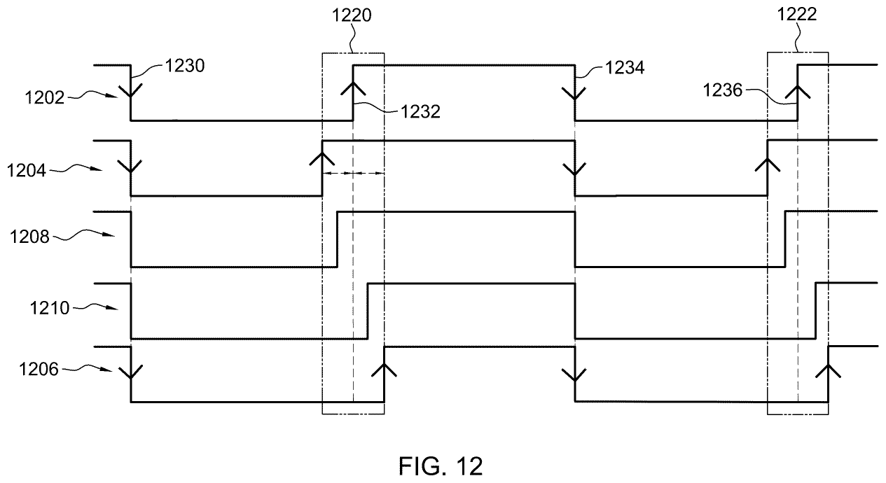

An example conceptual diagram of dual-edge pulse clock modeling in accordance with aspects described herein is shown by FIG. 10. FIG. 10 depicts input clock signal 1002 corresponding to the input clock and signal 1020 corresponding to the dual-edge pulse clock. As described above, a timing analyzer would conventionally treat edges 1022 and 1024 of the first pulse of the pulse clock 1020 as leading edges of two clock signals, and edges 1026 and 1028 as trailing edges of the two clock signals, resulting in incorrect pulse duration computations.

Instead, aspects model the two sets of pulses of the dual edge pulse clock—one set of pulses being those triggered by the leading edge of the input clock and another set of pulses as those triggered by the trailing edge of the input clock—using a set 1030 of different clocks, resulting in one rise and one fall per cycle, per clock. Specifically, the set of clocks includes a first clock ‘Clk_F’, given by signal 1032, to model the pulses triggered by the falling edges of the input clock, and a second clock ‘Clk_R’, given by signal 1034, to model the pulses triggered by the rising edges of the input clock. 1050, 1052, and 1054 all denote, respectively, one cycle of the input clock, Clk_F clock, and Clk_R clock.

Signal 1032 shows pulses triggered by the falling edges 1004 and 1008 of the input clock signal 1002. Using the first pulse of 1032 by way of example, the pulse includes rising edge 1036 and falling edge 1038 (denoted ‘Clk_F+’ and ‘Clk_F−’ respectively). This pulse is the only pulse of signal 1032 during the first cycle shown. The next pulse of signal 1032 is triggered on the next falling edge 1008 of the input clock signal 1002, which begins the next input clock cycle. Similarly, signal 1034 shows pulses triggered by the rising edges (1006 is shown in FIG. 10) of the input clock signal 1002. Using the first pulse of 1034 by way of example, the pulse includes rising edge 1040 and falling edge 1042 (denoted ‘Clk_R+’ and ‘Clk_R−’ respectively), and that is the only pulse of signal 1034 that occurs during that first cycle of the input clock. The next pulse of signal 1034 is triggered on the next rising edge of the input clock signal 1002.

The two clocks Clk_F and Clk_R (those represented collectively by 1030) can be propagated together in the circuit to mimic the two pulses per cycle desired for dual-edge timing. A polarity change is noted in the rising (trailing edge) triggered pulse of the input signal when modeling by Clk_R. Looking at signal 1020, the second pulse has a rising edge labeled Clk− and a falling edge labeled Clk+. However, when modeling this pulse (and subsequent pulses triggered by the rising edges of the input clock), there is a polarity change—trailing edge indicators (−) become leading edge indicators (+) and vice versa. Thus, edge 1040 of Clk_R is labeled Clk_R+ to indicate this rising edge as a leading edge of Clk_R and edge 1042 of Clk_R is labeled Clk_R− to indicate this falling edge as a trailing edge of Clk_R.

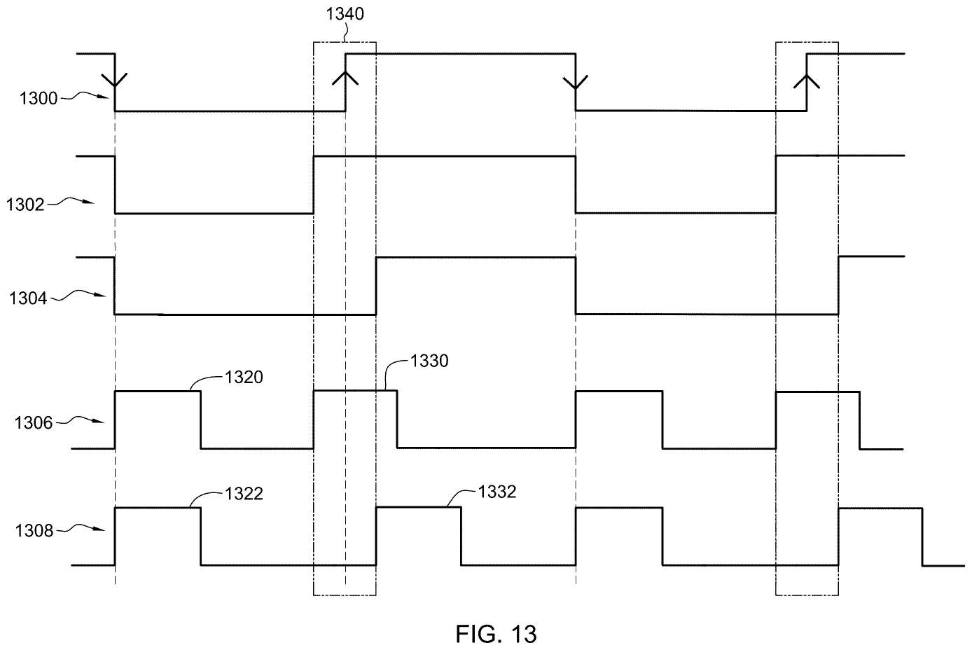

FIG. 11 depicts example clock definitions of a pair of clocks for modeling a dual-edge timing signal, in accordance with aspects described herein. A clock definition as used herein also refers to the definition of the clock signal of the clock being defined. A clock signal may be defined by a cycle time, a leading edge time, and a trailing edge time.

Referring to FIG. 11, signal 1104 corresponds to Clk_F. The leading edge of Clk_F is to coincide with the leading edge of the input clock. In this example, assume that the cycle time is 400 units and that an input clock cycle begins with a falling edge every 400 units of time beginning at time 0. Thus, the leading edge of Clk_F (labeled Clk_F−) occurs at time 0. The leading edge of Clk_R (Clk_R+) is to coincide with the trailing edge of the input clock (at time 200 here).

Table 1 provides the clock definitions of the input clock, Clk_F and Clk_R:

TABLE 1

| | |
|---|---|
| Cycle | Waveform |

| Clock Name | Time | Lead Edge | Trail Edge |
|---|---|---|---|
| Clk (input clock) | 400 | 0 | 200 |
| Clk_F | 400 | 0 | 200 |
| Clk_R | 400 | 200 | 400 |

This definition allows modeling both the falling-edge-triggered and the rising-edge-triggered pulses as leading edge pulses, with leading edges of Clk_F corresponding to the leading edges of the source clock and leading edges of Clk_R corresponding to the trailing edges of the source clock. This facilitates a clock rate step-up discussed earlier for locally clocking at a higher rate than the input clock.

It is noted that the respective duty cycles of Clk_F and Clk_R may not matter, for instance if all latch-to-latch paths are full-cycle leading to leading edge tests. In this example, both clocks have been defined to have a 50% duty cycle, but duty cycle may not be a concern for full cycle paths.

Based on this modeling, a process can perform timing analysis that includes pulse width testing to (i) determine pulse width of the leading-edge pulses of the dual-edge pulse clock as the width of the pulses of the one clock signal (Clk_F), and (ii) determine pulse width of the trailing-edge pulses of the dual-edge pulse clock as the widths of pulses of the other clock signal (Clk_R). This provides an advantage in that the analysis can find the pulse widths by looking at the pulse widths of the individual clock signals created, rather than determining them (incorrectly) from the dual-edge pulse clock signal as explained with reference to FIG. 9.

As described above, there may be uncertainty in the arrival time of the mid-cycle edge of the input clock. Conventional timing analysis tools model dual-edge timing using both cycle start (leading) edge and the mid-cycle (trailing) edge of the clock equally. However, the uncertainty associated with mid-cycle edge timing consumes the timing budget of latch-to-latch paths, and existing methods of modeling mid-cycle edge uncertainty are pessimistic, as they double-penalize two-cycle paths in situations when there should be no penalty.

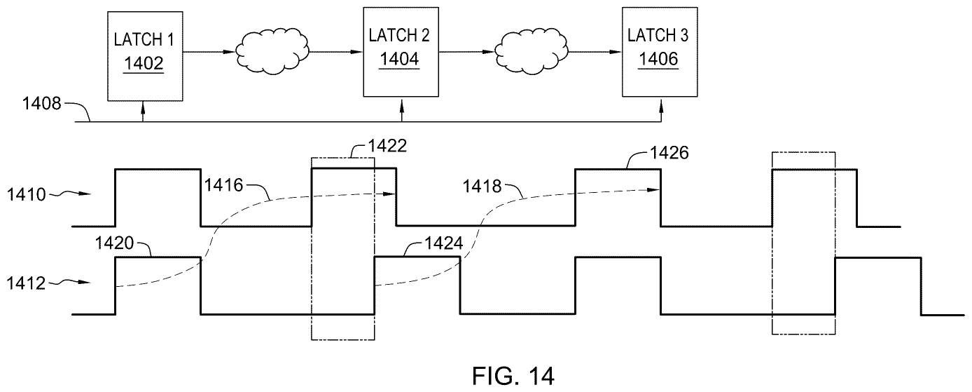

FIG. 12 conceptually depicts the concept of mid-cycle edge uncertainty relative to an input clock signal. The input clock signal is shown by signal 1202. Leading edge 1230 begins a cycle of the input clock that extends to edge 1234 where the next cycle begins. Rising edges 1232 and 1236 are mid-cycle edges. An uncertainty window (1220, 1222) is a window of time around the true mid-cycle point that represents uncertainty in the arrival time of the mid-cycle edge 1232, 1236. The window extends in each direction to an earliest arrival time (the left side of the window) and a latest arrival time (the right side of the window). It may be desired to model this physical phenomenon. In this example and examples described herein, the window is defined to be symmetrical around the true midpoint of the clock cycle (edge 1232 being at an example such midpoint), though aspects described herein can be applied to scenarios of asymmetry as between the uncertainty before the midpoint (early-arrival time) and the uncertainty after the midpoint (late-arrival time). In general, the physical phenomenon being modeled is that the percentage of time that a well-defined clock remains high versus low can vary when the circuit is physically fabricated. It may be desired for these percentages to be equal (50%/50%) but there can be variation. Since some timing paths may be sensitive to mid-cycle arrival time, testing for this may be desired. Such testing may be done by applying a mid-cycle uncertainty ‘penalty’.

In the example of FIG. 12, the mid-cycle edge can occur any time from N picoseconds (ps) earlier than the true (or ‘ideal’) midpoint of the cycle until N ps later than the true midpoint. Each window (e.g., 1220, 1222) is therefore 2N ps wide, centered on the true or ideal midpoint. N ps in this example is referred to as a mid-cycle penalty.

A conventional simulation tool might simulate the two extremes for mid-cycle edge arrival, the two extremes being an earliest arrival time and a latest arrival time. Signal 1204 models the earliest arrival time and signal 1206 models the latest arrival time. Using these as the two extremes, the actual input clock signal of the circuit when fabricated is expected to have a mid-cycle arrival time coinciding with either of these two extremes of falling somewhere between them. As a result, the actual input clock signal of the circuit will have a signal that looks like one of: (i) a signal in which the mid-cycle edge arrives at the true cycle midpoint (e.g., signal 1202), (ii) a signal in which the mid-cycle edge arrives at the earliest arrival time (e.g., signal 1204), (iii) a signal in which the mid-cycle edge arrives between the earliest arrival time and the true cycle midpoint (e.g., signal 1208), (iv) a signal in which the mid-cycle edge arrives between the true cycle midpoint and the latest arrival time (e.g., signal 1210), or (v) a signal in which the mid-cycle edge arrives at the latest arrival time (e.g., signal 1206).

It is noted that testing can assume there is no cycle-to-cycle jitter in a given signal, meaning that the uncertainty in the mid-cycle edge arrival time does not change over time and thus the mid-cycle edge arrival time will remain constant for that signal, and can further assume that the mid-cycle edge occurs at the same time across the entire fabricated chip (or at least the portion of the chip that is clocked based on the subject input clock).

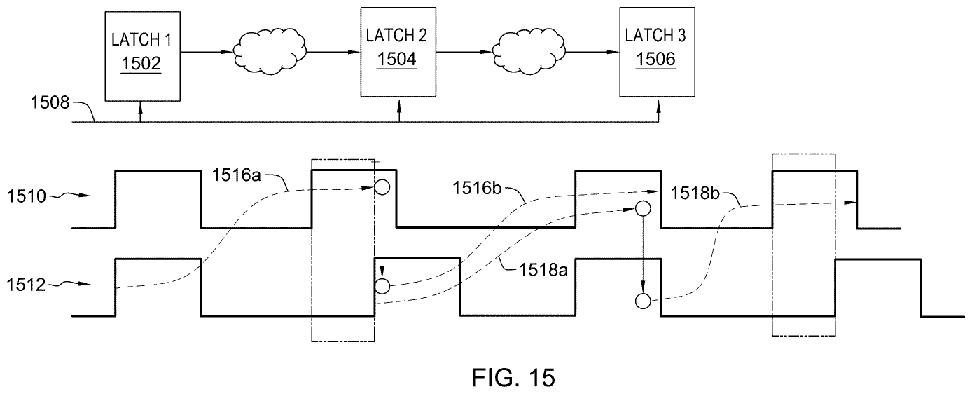

FIG. 13 conceptually depicts an example modeling of mid-cycle edge uncertainty by a conventional timing analysis tool. This modeling may be performed pursuant to constraints checking processing, sometimes referred to as a “setup test” that includes testing for latest edge arrival time (late-arrival mode or timing) versus earliest edge arrival time (early-arrival mode or timing). Signal 1300 represents the ‘ideal’ input clock (Clk−) with a mid-cycle arrival time at the midpoint of the cycle clock. Signal 1302 represents clock Clk− in an early-arrival mode (specifically an earliest mid-cycle edge arrival time, N ps earlier than the true midcycle point), and signal 1304 represents clock Clk− in a late-arrival mode (specifically a latest mid-cycle edge arrival time, N ps later than the true midcycle point).

Example modeling of this mid-cycle edge uncertainty under the early-arrival and late-arrival scenarios by a conventional timing analysis tool is shown by signals 1306 and 1308, respectively. Signals 1306 and 1308 shown the output of a pulse generator taking signal 1302 or 1304, respectively, as input. Notably, the mid-cycle edge uncertainty is modeled as a constant penalty incorporated into the mid-cycle edge arrival time, and as reflected by pulse widths that are extended for a duration larger than the uncertainty window 1340. Thus, falling-edge-triggered pulses 1320 and 1330 of signal 1306 and rising-edge-triggered pulses 1322 and 1332 of signal 1308 are shown with pulse durations longer than the width of the uncertainty window 1340.

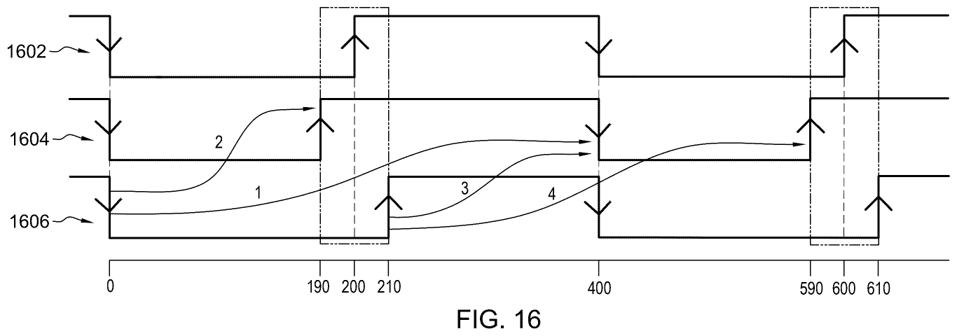

The above modeling can present problems relative to multi-cycle paths. To illustrate, consider FIG. 14 conceptually illustrating data launch and capture in a single-cycle path for early and late mid-cycle edge arrival scenarios. Latches 1402, 1404, and 1406 are shown in sequential connection (with optional one or more other components therebetween). Latches 1402, 1404, and 1406 are all clocked by a dual-edge pulse generator's output signal on line 1408. The output signal 1408 under an early-arrival scenario is given by signal waveform 1410 and under a late-arrival scenario is given by signal waveform 1412.

In an example setup test, one possibility corresponds to a ‘single-cycle path’ in which data is launched from one latch by one pulse and captured at a sequentially-next latch by the next pulse. Thus, one possibility (represented for convenience by arrow 1416) for the single-cycle path is that data is launched by a pulse generated based on a falling edge of the input clock and is captured by a pulse generated based on the next rising edge of the input clock. The other possibility (represented for convenience by arrow 1418) for the single-cycle path is that data is launched by a pulse generated based on a rising edge of the input clock and is captured by a pulse generated based on the next falling edge of the input clock. In both scenarios, the time for the setup test is to be reduced by an amount equal to the mid-cycle penalty (e.g., N ps), as the timing under each scenario is N ps faster than half of the clock cycle time—under the early-arrival scenario, the data is captured N ps early and the penalty is realized at the capturing end, while under the late-arrival scenario, the data is launched N ps late and the penalty is realized at the launching end. Effectively, there is a penalty of N ps (equal to mid-cycle uncertainty).

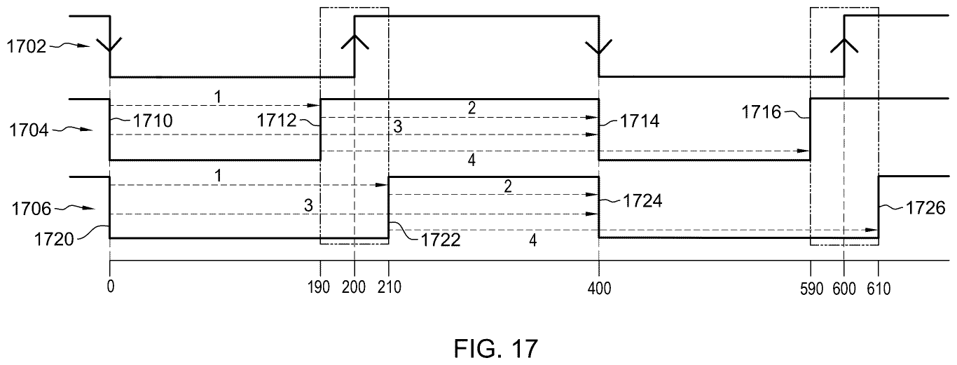

A problem can arise in some multi-cycle scenarios in which data flows through transparent latch(es). FIG. 15 conceptually illustrates data launch and capture in a two-cycle path for early and late mode mid-cycle edge arrival scenarios. Latches 1502, 1504, and 1506 are shown in sequential connection (with optional one or more other components therebetween). Latches 1502, 1504, and 1506 are all clocked by a dual-edge pulse generator's output signal on line 1508. The output signal 1508 under an early-arrival scenario is given by signal waveform 1510 and under a late-arrival scenario is given by signal waveform 1512.

In this example setup test, a ‘two-cycle path’ sees data launched from one latch flow through a ‘transparent’ sequentially-next second latch and captured at another latch by the next pulse. Thus, one possibility, collectively represented for convenience by arrows 1516a and 1516b and using latches 1502, 1504, and 1506 as an example, is that data (i) is launched from latch 1502 by a first pulse generated based on a first falling edge of the input clock, (ii) flows through latch 1504 on account that the data arrives at latch 1504 during the active region of a second, and sequentially-next pulse, which is generated based on the rising edge of the input clock, then (iii) is captured by latch 1506 by a third pulse sequentially-after the second pulse, where the third pulse is generated based on a second falling edge of the input clock. The other possibility, collectively represented for convenience by arrows 1518a and 1518b and using latches 1502, 1504 and 1506 as an example, is that data (i) is launched from latch 1502 by a first pulse generated based on a first rising edge of the input clock, (ii) flows through latch 1504 on account that the data arrives at latch 1504 during the active region of a second, and sequentially-next pulse, which is generated based on the subsequent falling edge of the input clock, then (iii) is captured by latch 1506 by a third pulse sequentially-after the second pulse, where the third pulse is generated based on a second rising edge of the input clock.

Under this two-cycle path, the mid-cycle latch, which is between the launching and capturing latches and corresponds to the mid-cycle of the input clock cycle, is transparent during the active region of the corresponding dual-edge clock pulse, and thus incoming data arriving at that latch during the active region of the pulse will flush through to the capturing latch. In such a setup test where data is launched from a first latch by a first pulse and arrives at a second, next latch during a subsequent (second) pulse to be transparently flushed through the second latch and captured at a third latch by a third pulse, this is a multi-cycle path and should not necessarily be assessed a mid-cycle penalty under an example scenario in which conventional timing analyzers apply the penalty. For instance, in the example of FIG. 15, the path 1516a-1516b does not have a mid-cycle edge penalty as the data arrives late (outside of the mid-cycle edge window) at the second latch but still within the transparent region, and thus will flush through the second latch and arrive ‘on-time’ at the third latch; the first and third pulses are aligned to the input clock cycle time which does not have any uncertainty associated with it. The path 1518a-1518b, however, is penalized by twice the mid-cycle edge penalty (2*N) when there should be no penalty. Specifically, the launching edge corresponds to a first pulse that is delayed by the mid-cycle penalty (N ps), the data flushes through the intermediate latch during the transparent region of a second pulse, and is then captured at the capturing latch by a pulse that is early by the mid-cycle penalty (N ps). The data is launched at an initial delay of N ps and captured earlier by N ps, resulting in a double penalty of 2*N. However, this path should not be penalized as launch and capture are at the clock cycle boundaries which do not have any uncertainty.

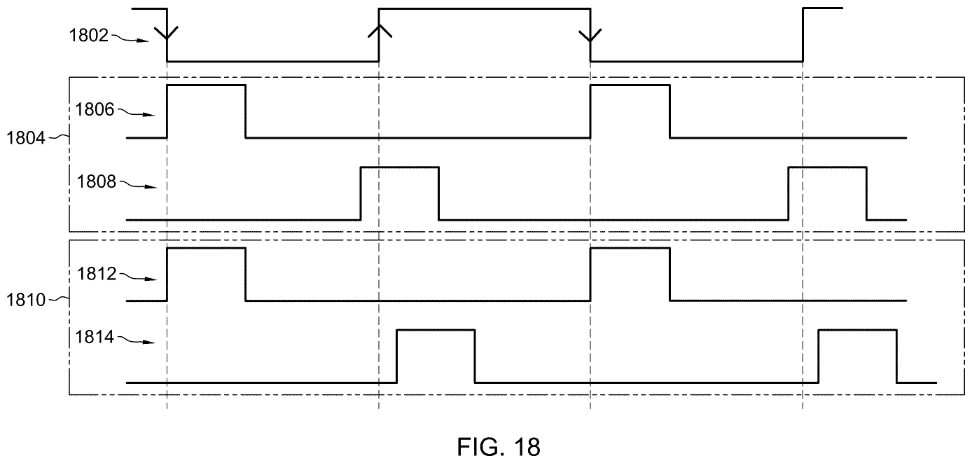

FIG. 16 further illustrates the example of improper mid-cycle edge penalization. Three signals are shown against a timeline in FIG. 16. Signal 1602 represents the ‘ideal’ input clock Clk− with cycle start times of 0, 400, etc., and mid-cycle arrival times at the midpoint of the cycle clocks, i.e., at times 200, 600, etc. Signal 1604 represents clock Clk− in the early-arrival scenario. Using the first cycle as an example, the earliest mid-cycle edge arrival time is time 190, which is N=10 ps earlier than the true midcycle point at time 200. Signal 1606 represents clock Clk− in the late-arrival scenario. The latest mid-cycle edge arrival time is time 210, which is N=10 ps later than the true midcycle point at time 200.

Mid-cycle edge uncertainty is modeled as a constant penalty (e.g., N=10 ps) and baked into mid-cycle edge arrival time. There are four paths, labeled 1 through 4 in FIG. 16, that are of interest and impacted by mid-cycle edge penalty. In path 1, the data is launched by the falling edge at time 0 and is captured by the next falling edge (at time 400). This is a two-cycle situation in which no penalty is applied and mid-cycle time is largely irrelevant. In path 2, the data is launched by the falling edge at time 0 and is captured by the next edge—the rising edge at time 190. This is a single-cycle, early-arrival situation in which a 10 ps penalty is applied on account that the data arrives 10 ps early. In path 3, the data is launched by the rising edge at time 210 and is captured by the next edge—the falling edge at time 400. This too is a single-cycle situation, here a late-arrival situation, in which a 10 ps penalty is applied on account that the data is launched 10 ps late. In path 4, the data is launched by the mid-cycle edge, here the rising edge at time 210, and is captured by the next rising edge at time 590. This is a two-cycle situation in which no penalty should be applied to path 4.

For context as to why early-mode and late-mode waveforms are involved in path timing, it is noted that a setup test at the data input of a latch ensures that the signal at the data pin should arrive (or be stable) well-before the clock edge. The setup test is performed between two pins—the data pin and the clock pin—and involves comparing the data signal arrival time against the clock signal arrival time. Here, this comparison is performed between the late-mode data signal arrival time and early-mode clock signal. Therefore, in various figures here, paths are shown to start from the late-mode waveform indicating launch from a late-mode clock signal at the launching latch, and end at the early-mode waveform indicating capture by an early-mode clock at the capturing latch. Static timing analysis tools can use two quantities/numbers to represent the arrival time of each signal at any point in the circuit, namely late-mode arrival time and early-mode arrival time. Multiple paths can converge to a point in the circuit, and arrival times from these paths may be different; late-mode arrival time represents latest arrival time from all incoming paths and early-mode arrival time represents earliest arrival time from all incoming paths.

A problem with existing modeling of mid-cycle edge uncertainty in dual-edge timing scenarios is that, while the single cycle paths are correctly penalized by one mid-cycle edge penalty (10 ps in the examples above), neither of the two-cycle paths are to be penalized. However, the situation of path 4 in the above sees this two-cycle path being penalized by twice (2×) the mid-cycle edge penalty, which is improper. In dual edge timing, two-cycle (and more generally 2*k-cycle, where k=1, 2, 3, . . . ) paths should not receive any penalty.

In accordance with aspects described herein, this may be addressed by using a four-clock approach. Initially, testing can test the two extreme cases—case 1 being represented by signal 1604 (a ‘Clk_E’ in which the mid-cycle edge arrival is earliest) and case 2 being represented by signal 1606 (a ‘Clk_L’ in which the mid-cycle edge arrival is latest). Thus, based on concepts described earlier in which dual-edge timing for one input waveform is modeled using two clocks, modeling the two cases noted above uses four clocks.

The reason for the double penalty conventionally was application of the penalty in the opposite direction between the late-arrival and early-arrival times. In hardware, it is either case 1 or case 2 (or any waveform between the two), but these situations do not co-occur in hardware. Mid-cycle edge uncertainty requirements are satisfied if timing is closed for two clock waveforms (1604 and 1606) independently. Unlike existing approaches, when using two clocks there may be no difference between the late-arrival and early-arrival waveforms.

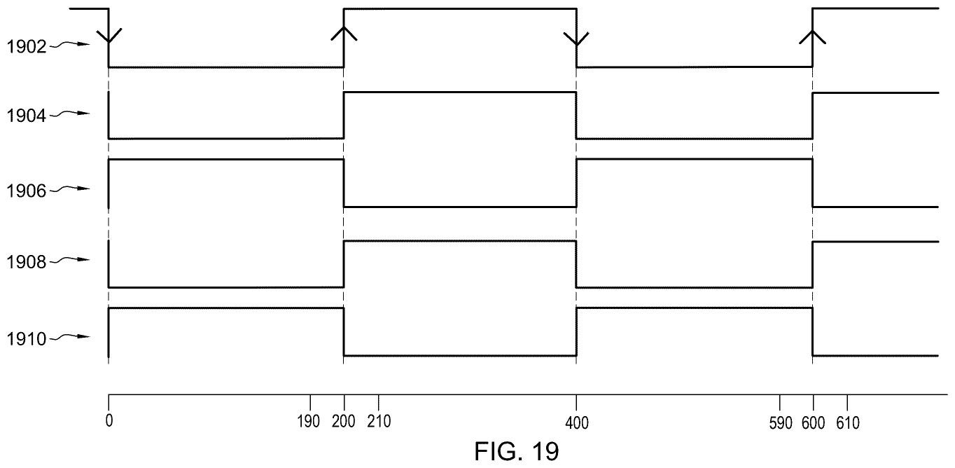

FIGS. 17-18 conceptually depict an example approach for modeling mid-cycle edge arrival scenarios, in accordance with aspects described herein. Referring first to FIG. 17, signal 1702 presents the ideal clock with cycle time of 400 ps and mid-cycle edge timing at 200 ps. Signal 1704 presents the case 1 early-arrival scenario (Clk_E) and signal 1706 presents the case 2 late-arrival scenario (Clk_L). Signals 1704 and 1706 can be interpreted as input clocks to the pulse generator, and the waveforms discussed with reference to FIG. 18 as the resulting pulses showing the output of the pulse generator.

Four path scenarios are considered relative to each of case 1 and 2. The first path scenario (path 1) corresponds to data launch at the leading edge of a cycle and capture at the mid-cycle edge. The second path scenario (path 2) corresponds to data launch at the mid-cycle edge and capture at the leading edge of the next cycle. Path 1 and path 2 are single-cycle scenarios. The third path scenario (path 3) corresponds to data launch at the leading edge of the cycle and capture at the leading edge of the next cycle. The fourth path scenario (path 4) corresponds to data launch at the mid-cycle edge of a cycle and capture at the mid-cycle edge of the next cycle.

Table 2 presents timing characteristics in (ps) of the four paths 1 through 4 relative to signals 1704 (Clk_E) and 1706 (Clk_L).

TABLE 2

| | Path 1 | Path 2 | Path 3 | Path 4 |
|---|---|---|---|---|
| Clk_E | 190 | 210 | 400 | 400 |
| Clk_L | 210 | 190 | 400 | 400 |
| Effective Budget | 190 | 190 | 400 | 400 |
| Penalty | 10 | 10 | 0 | 0 |

As shown, the path lengths that are 190 ps (edge 1710 to edge1712, edge 1712 to edge 1714, edge 1720 to edge 1722, and edge 1722 to edge 1724) are properly penalized by a 10 ps mid-cycle edge penalty, and the path lengths that are 400 ps (edge 1710 to edge 1714, edge 1712 to edge 1716, edge 1720 to edge 1724, and edge 1722 to edge 1726) are properly not penalized by a mid-cycle edge penalty. In particular, path 4 starting at the mid-cycle (rising) edge (1712 or 1722) and ending at the next mid-cycle (rising) edge (1716 or 1726, respectively) is properly assessed no penalty.

FIG. 18 depicts the four-clock approach used. Signal 1802 presents the ideal clock with the mid-cycle edge at the true midpoint of the cycle. The approach models a first dual-edge pulse clock (Clk_E) based on an early-arrival source clock using a set 1804 of clock signals as early-arrival clock signals that include a first clock signal 1806 that models pulses, of the first dual-edge pulse clock, triggered based on leading edges (falling in this example) of the source clock, and a second clock signal 1808 that models pulses, of the first dual-edge pulse clock, triggered based on the trailing edges (rising in this example) of the early-arrival source clock, the trailing edges being mid-cycle edges of the source clock. The approach also models a second dual-edge pulse clock (Clk_L) based on a late-arrival source clock using a set 1810 of clock signals as late-arrival clock signals that include a first clock signal 1812 that models pulses, of the second dual-edge pulse clock, triggered based on leading edges (falling in this example) of the source clock, and a second clock signal 1814 that models pulses, of the second dual-edge pulse clock, triggered based on the trailing edges (rising in this example) of the late-arrival source clock, the trailing edges being mid-cycle edges of the source clock.

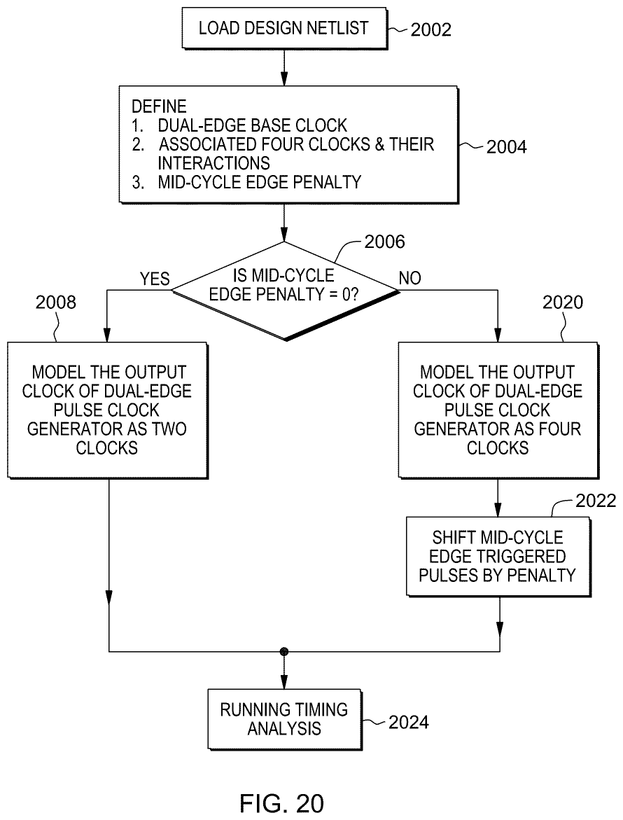

FIG. 19 depicts example clock definitions of the set of four clocks for modeling two dual-edge timing signals (corresponding to the two cases above), in accordance with aspects described herein. Signal 1902 presents the ideal clock with the mid-cycle edge at the true midpoint of the cycle, for reference. The four defined clocks are represented by a respective four signals: 1904 and 1906 collectively for simulating the early-arrival scenario of case 1, and signals 1908 and 1910 collectively for simulating the late-arrival scenario of case 2.

Table 3 depicts example clock definitions for the input clock and four clocks discussed above—labeled Clk_F_E (early-arrival, falling edge pulse (signal 1904)), Clk_R_E (early-arrival, rising edge pulse (signal1906)), Clk_F_L (late-arrival, falling edge pulse (signal 1908)), and Clk_R_L (late-arrival, rising edge pulse (signal 1910)).

TABLE 3

| | |
|---|---|
| Cycle | Waveform |

| Clock Name | Time | Lead Edge | Trail Edge |
|---|---|---|---|
| Clk (input clock) | 400 | 0 | 200 |
| Clk_F_E | 400 | 0 | 200 |
| Clk_R_E | 400 | 200 | 400 |
| Clk_F_L | 400 | 0 | 200 |
| Clk_R_L | 400 | 200 | 400 |

It is seen that the case 1 (early-arrival) clocks, Clk_F_E and Clk_R_E, are defined identically to the case 2 (late-arrival) clocks Clk_F_L and Clk_R_L. It is noted that early mode and late mode clocks do not have early or late arrival times in these definitions because clock definitions contain ideal times of leading and trailing edges; and the early and late characteristics are associated with arrival times when signals are propagated through the circuit.

For testing purposes, it is possible for one testing run to simulate the minimum duty cycle (e.g., late-arrival case) and a different testing run to simulate the maximum duty cycle (e.g., early-arrival case). However, it may be desired for reasons of efficiency, including time and resource savings (in power consumption and cost), to simulate both scenarios as part of a single run. Although the circuit, when fabricated, would not exhibit both early-arrival and late-arrival behavior, a single simulation to simulate both cases raises a potential problem in terms of conflicting signals. The simulation makes measurements and compares signals that are consistent during a run. It is undesirable for any measurements/comparisons to be made between the signal timings associated with the minimum duty cycle and those associated with the maximum duty cycle. As such, the two sets of clocks are to be mutually excluded from each other when performing the simulation in the same run, that is, the early-arrival pair of clocks are to be excluded from the late-arrival pair of clocks.

In accordance with aspects described herein, the above mutual exclusion can be accomplished using phase tagging. As explained previously, timing windows (earliest and latest times that a signal can switch) are propagated and multiple such timing windows can be propagated simultaneously by differentiating them using phase tags. Thus, a process can apply tags to the early-arrival clock signals and the late-arrival clock signals and then perform a timing analysis, where the timing analysis performs a single timing analysis run that uses both the early-arrival clock signals and the late-arrival clock signals, and mutually excludes the early-arrival clock signals from the late-arrival clock signals based on the applied tags to avoid conflicts between the early-arrival clock signals and the late-arrival clock signals in the single timing analysis run. This advantageously mimics the effect of performing two independent runs; instead they are folded into one run, leading to a sometimes drastic reduction in the resources consumed for the testing (compute cycles, power, amount of time, etc.).

Table 4 presents the mutual exclusions that can be set up using phase tagging under the described scenario (using an ‘X’ in cells to indicate that the pair of clocks corresponding to the cell are excluded):

TABLE 4

| | Clk_F_E | Clk_R_E | Clk_F_L | Clk_R_L |
|---|---|---|---|---|
| Clk_F_E | | | X | X |
| Clk_R_E | | | X | X |
| Clk_F_L | X | X | | |
| Clk_R_L | X | X | | |

Table 5 presents invalid flush propagations between the four clocks (using an ‘X’ in cells to indicate that the pair of clocks corresponding to the cell represent an invalid flush propagation):

TABLE 5

| | Clk_F_E | Clk_R_E | Clk_F_L | Clk_R_L |
|---|---|---|---|---|
| Clk_F_E | X | | n/a | n/a |
| Clk_R_E | | X | n/a | n/a |
| Clk_F_L | n/a | n/a | X | |
| Clk_R_L | n/a | n/a | | X |

Invalid flush propagation relates to mid-cycle latch transparency during the active region of the clock. When data arrives at a latch during that active region, the data is ‘flushed’ through the latch. Data launched from a latch based on a falling edge pulse (pulse generated based on a falling edge of the input clock) flushes through the next latch based on occurrence of a next pulse, which is always expected to be a rising edge pulse (pulse generated based on a rising edge of the input clock). Similarly, data launched from a latch based on a rising edge pulse (pulse generated based on a rising edge of the input clock) flushes through the next latch based on occurrence of a next pulse, which is always expected to be a falling edge pulse (pulse generated based on a falling edge of the input clock). Consequently, in the early-arrival scenario, a propagation flush of data based on consecutive falling edges or consecutive rising edges of Clk_E would be invalid, as would a propagation flush of data based on consecutive falling edges or consecutive rising edges of Clk_L. Since Clk_E signals are mutually excluded from Clk_L signals as described above, the situations of mixed early-late-arrival clock signals are indicated as not applicable (n/a).

In accordance with some aspects described herein, a process can identify, based on the input specification, dual-edge pulse clocks of a setup test, of timing analysis to be performed, for testing mid-cycle edge uncertainty of the source clock in a multi-cycle for instance a two-cycle path in which data provided from a latch of the circuit is to be flushed through one (or more) sequentially-next latch(es) of the circuit and arrive at another latch of the circuit. This testing can be based on an earliest mid-cycle edge arrival time of the source clock and a latest mid-cycle edge arrival time of the source clock, as described. Further, the process can model a first of the dual-edge pulse clocks based on an early-arrival source clock, representing the earliest mid-cycle edge arrival time. This modeling can use a respective set of clock signals, as ‘early-arrival clock signals’, that include a first clock signal that models pulses, of the first dual-edge pulse clock, triggered based on leading edges of the early-arrival source clock, and a second clock signal that models pulses, of the first dual-edge pulse clock, triggered based on trailing edges of the early-arrival source clock, the trailing edges of the early-arrival source clock being mid-cycle edges of the early-arrival source clock. The process can also model a second of the dual-edge pulse clocks based on a late-arrival source clock, representing the latest mid-cycle edge arrival time. This modeling can use a respective set of clock signals, as ‘late-arrival clock signals’, that include a first clock signal that models pulses, of the second dual-edge pulse clock, triggered based on leading edges of the late-arrival source clock, and a second clock signal that models pulses, of the second dual-edge pulse clock, triggered based on trailing edges of the late-arrival source clock, the trailing edges of the late-arrival source clock being mid-cycle edges of the late-arrival source clock. Additionally, the first dual-edge pulse clock can represent one of (i) a first duty cycle waveform and (ii) a second duty cycle waveform, where the second clock signal of the early-arrival clock signals (for modeling this first dual-edge pulse clock), includes pulses with leading edges corresponding to the earliest mid-cycle arrival time. Further, the second dual-edge pulse clock can represent the other of the first duty cycle waveform and the second duty cycle waveform, where the second clock signal of the last-mode clock signals (for modeling this second dual-edge pulse clock) includes pulses with leading edges corresponding to the latest mid-cycle edge arrival time.

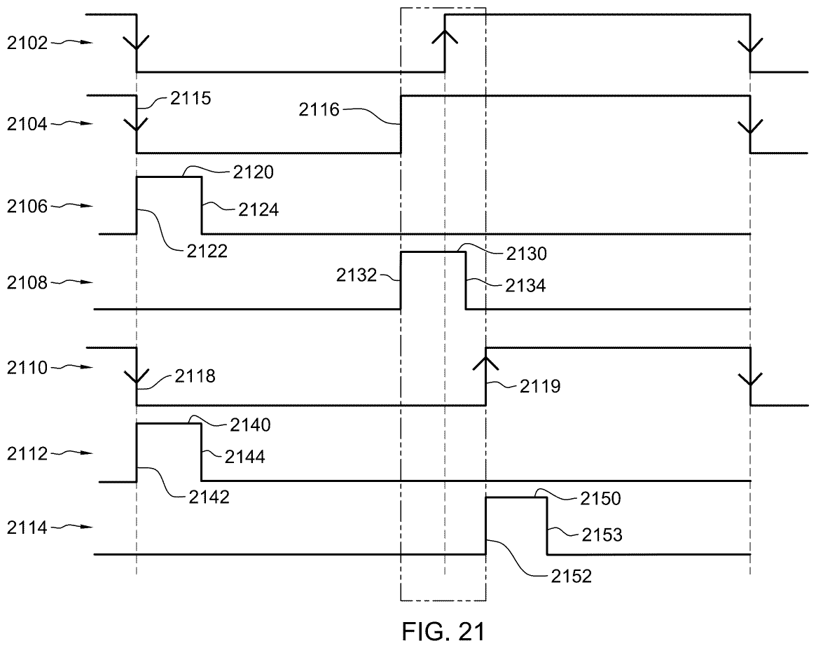

FIG. 20 depicts an example process for setup of a dual-edge timing analysis in accordance with aspects described herein. The process loads (2002) the design netlist (along with any other needed input specification data) then defines (2004), using timing tool commands, a dual-edge base clock, associated clocks and their interactions, and a mid-cycle edge penalty/uncertainty. If no mid-cycle edge penalty testing is to be performed, the penalty can be set to zero. The process continues by determining (2006) whether the mid-cycle edge penalty=0. This inquiry determines whether the timing analysis is to assume a mid-cycle edge uncertainty and therefore account for that. If there is such uncertainty, this is accounted for using four clocks as described herein. Otherwise, if there is no mid-cycle edge uncertainty, then the modeling uses two clocks as described herein.

Thus, if at 2006 it is determined that mid-cycle edge penalty is zero (2006, Y), then the process continues by modeling (2008), using timing tool commands, the output clock of the dual-edge pulse generator (i.e., the dual-edge pulse clock) as two clocks and runs (2024) the timing analysis based on the two clocks. If instead it is determined at 2006 that the mid-cycle edge penalty is not zero (2006, N), then the process continues by modeling (2020), using timing tool commands, the output clock of the dual-edge pulse generator (i.e., the dual-edge pulse clock) as four clocks. At this point, the process can shift the pulses (triggered by the mid-cycle edge) by the mid-cycle penalty, which is described in further detail below. The process then runs (2024) the timing analysis based on the four clocks.

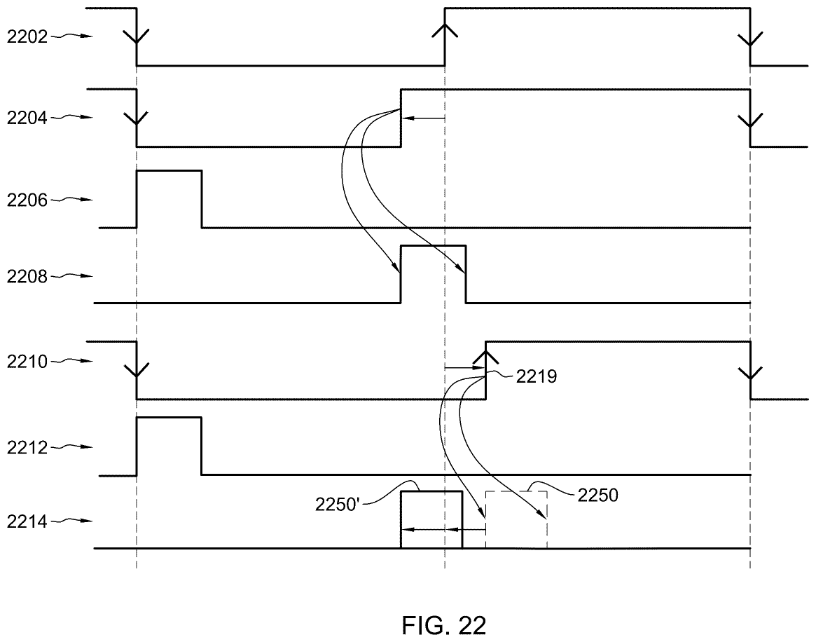

FIGS. 21-23 depict examples of shifting clock pulses triggered by a mid-cycle edge, in accordance with aspects described herein. Referring initially to FIG. 21 where no shifting is performed, signal 2102 presents the ideal clock with the mid-cycle edge at the true midpoint of the cycle, for reference. A single input clock cycle is shown in this figure. Signal 2104 presents the early-arrival input clock with mid-cycle uncertainty of N as part of the mid-cycle (rising) edge latency at edge 2116. Signals 2106 and 2108 correspond to the two clocks used in accordance with aspects described herein for dual-edge modeling of the early-arrival input clock 2104. Specifically, signal 2106 shows the output early-arrival falling edge pulse clock with pulse 2120 generated at the start of the input clock cycle and having leading edge 2122 (Clk_F+) and trailing edge 2124 (Clk_F−). Signal 2108 shows the output early-arrival rising edge pulse clock with pulse 2130 generated at the early-arrival mid-cycle edge 2116 of input clock signal 2104 and having leading edge 2132 (Clk_R+) and trailing edge 2134 (Clk_R−).

Continuing with FIG. 21, signal 2110 presents the late-arrival input clock with mid-cycle uncertainty of N as part of the mid-cycle (rising) edge latency at edge 2119. Signals 2112 and 2114 correspond to the two clocks used in accordance with aspects described herein for dual-edge modeling of the late-arrival input clock 2110. Specifically, signal 2112 shows the output late-arrival falling edge pulse clock with pulse 2140 generated at the start of the input clock cycle and having leading edge 2142 (Clk_F+) and trailing edge 2144 (Clk_F−). Signal 2114 shows the output late-arrival rising edge pulse clock with pulse 2150 generated at the late-arrival mid-cycle edge 2119 of input clock signal 2110 and having leading edge 2152 (Clk_R+) and trailing edge 2153 (Clk_R−).

FIG. 21 shows the pulse generator input clock with mid-cycle uncertainty of N ps baked into the mid-cycle edge (rising edge) clock latency and dual edge pulse output clocks because of this way of modelling mid-cycle uncertainty.

FIG. 22 depicts an example of shifting the minimum duty clock waveform, which is the clock signal of the late-arrival clock in this example. Existing uncertainty models led to different late and early-arrival scenario arrival times of the mid-cycle edge pulse. The proposed model does not have such differences, and therefore the late-arrival (minimum duty cycle waveform in this example) mid-cycle edge pulse should be shifted by −2*N ps, where N is mid-cycle edge uncertainty. In other words, existing uncertainty models have different early-mode and late-mode arrival times of the mid-cycle edge, but aspects described herein propose having no difference between the early-mode and late-mode arrival times. Shifting, as shown by FIG. 22, achieves this. That is, FIG. 22 illustrates how to create dual-edge pulse clocks for the Clk_E clock from the input clock to the pulse generator where mid-cycle uncertainty is modelled in a conventional manner. Similarly, FIG. 23 illustrates how to create dual-edge pulse clocks for the Clk_L. Note that there is no difference in early-mode and late-mode arrival times of the mid-cycle edge of Clk_E and similarly for Clk_L. In FIG. 22, after shifting, the late-mode waveform (2214) matches with the early-mode waveform (2208).

To illustrate, FIG. 22 shows signal 2202 presenting the ideal clock with the mid-cycle edge at the true midpoint of the cycle, for reference. Signals 2204, 2206, and 2208 mirror those of signals 2104, 2106 and 2108 of FIG. 21 presenting the early-arrival mid-cycle uncertainty scenario. Signal 2210 presents the late-arrival input clock with mid-cycle uncertainty of N as part of the mid-cycle (rising) edge latency at edge 2219. Signals 2212 and 2214 correspond to the two clocks used in accordance with aspects described herein for dual-edge modeling of the late-arrival input clock 2210. Specifically, signal 2212 shows the output late-arrival falling edge pulse clock consistent with FIG. 21. Signal 2214 shows an example alternative output late-arrival rising edge pulse clock (as an alternative to signal 2114 of FIG. 21) in which a pulse (labeled 2250) that would otherwise occur at the late-arrival mid-cycle edge 2219 of input clock signal 2210 is shifted earlier (as shown by pulse 2250′) by an amount equal to 2*N ps. In this manner, a process can shift the pulses of a clock signal of the late-arrival clock signals (specifically the signal modeling pulses triggered based on the trailing (mid-cycle) edges of the late-arrival source clock) earlier by a difference between the latest mid-cycle edge arrival time and the earliest mid-cycle edge arrival time, the difference being twice the mid-cycle edge penalty of N.

FIG. 23 depicts an example of shifting the maximum duty clock waveform, which is the clock signal of the early-arrival clock in this example. Existing uncertainty models led to different late and early-arrival arrival times of the mid-cycle edge pulse. The proposed model does not have such differences, and therefore the early-arrival (maximum duty cycle waveform in this example) mid-cycle edge pulse should be shifted by 2*N ps, where N is mid-cycle edge uncertainty. To illustrate, FIG. 23 shows signal 2302 presenting the ideal clock with the mid-cycle edge at the true midpoint of the cycle, for reference. Signals 2310, 2312, and 2314 mirror those of signals 2110, 2112 and 2114 of FIG. 21 presenting the late mode mid-cycle uncertainty scenario. Signal 2304 presents the early-arrival input clock with mid-cycle uncertainty of N as part of the mid-cycle (rising) edge latency at edge 2319. Signals 2306 and 2308 correspond to the two clocks used in accordance with aspects described herein for dual-edge modeling of the early-arrival input clock 2304. Specifically, signal 2306 shows the output early-arrival falling edge pulse clock consistent with FIG. 21. Signal 2308 shows an example alternative output early-arrival rising edge pulse clock (as an alternative to signal 2108 of FIG. 21) in which a pulse (labeled 2350) that would otherwise occur at the early-arrival mid-cycle edge 2319 of input clock signal 2304 is shifted later (as shown by pulse 2350′) by an amount equal to 2*N ps. In this manner, a process can shift the pulses of a clock signal of the early-arrival clock signals (specifically the signal modeling pulses triggered based on the leading edges of the early-arrival source clock) later by a difference between the latest mid-cycle edge arrival time and the earliest mid-cycle edge arrival time, the difference being twice the mid-cycle edge penalty of N.

Thus, aspects described herein provide approaches for the definitions of clock signals for static timing analysis, where the clock signals model dual-edge triggered generated clocks. The clock signals can be defined to facilitate correct performance and timing in pulse width tests. Additionally or alternatively, the clock signals can enable a timing margin to account for mid-cycle uncertainty for single cycle paths. Additionally or alternatively, the clock signals can enable removing a timing margin for a mid-cycle penalty for two-cycle paths involving level-sensitive latches. Additionally or alternatively, the clock signals can enable a timing margin to account for mid-cycle uncertainly for odd cycle (1-cycle, 3 cycle, etc.) paths involving level-sensitive latches. Additionally or alternatively, the clock signals can enable removing a timing margin for mid-cycle penalty for all even multi-cycle (2-cycle, 4-cycle, etc.) paths involving level-sensitive latches. Additionally or alternatively, the clock signals can enable combining multiple timing runs to model a full range—early-arrival through late-arrival—of mid-cycle uncertainty involving level-sensitive latches. In examples, combining timing runs involves selective clock pair exclusions, for instance based on phase tagging.

Aspects may be particularly useful for in dual-edge timing scenarios, which are used for power savings in processing circuits (processors, central processing units) of computing systems.

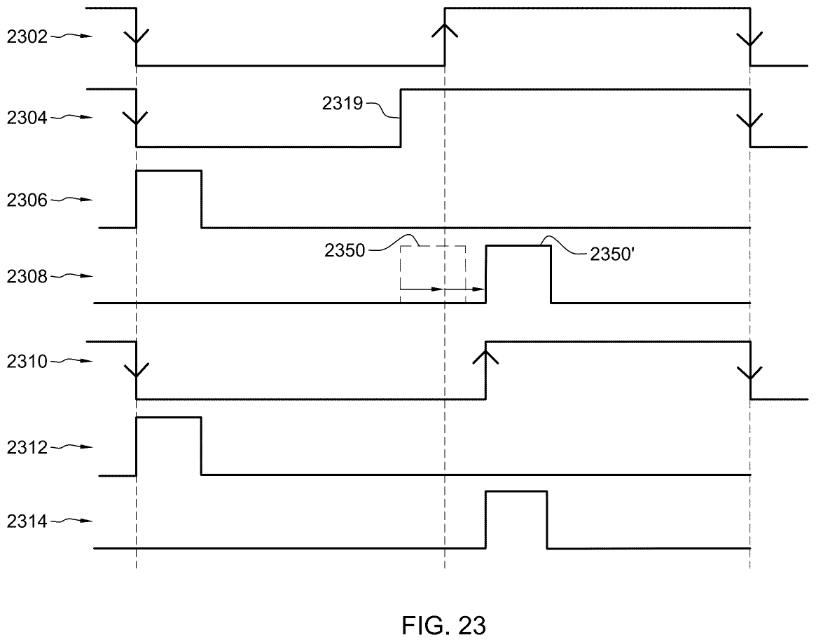

FIG. 24 depicts further details of example circuit design testing code (e.g., circuit design testing code 150 of FIG. 1) to incorporate and/or use aspects described herein. In one or more aspects, circuit design testing code 150 includes, in one example, various sub-modules to be used to perform testing of a circuit design, which includes setup (clock definitions, etc.) for the testing. The sub-modules are, e.g., computer readable program code (e.g., instructions) in computer readable media, e.g., storage (persistent storage 113, cache 121, storage 124, other storage, as examples). The computer readable storage media may be part of one or more computer program products and the computer readable program code may be executed by and/or using one or more computing devices (e.g., one or more computers, such as computer(s) 101, computers of cloud 105/106, and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute one or more of the sub-modules and/or portions thereof. Many examples are possible.

Referring to FIG. 24, circuit design testing code 150 includes dual-edge pulse clock identifying code 2402 for identifying, from an input specification of a circuit, dual-edge pulse clock(s); clock modeling code 2404 for modeling the identified dual-edge pulse clock(s); and timing analysis code 2406 for performing timing analysis based on this modeling. These aspects are described in further detail herein.

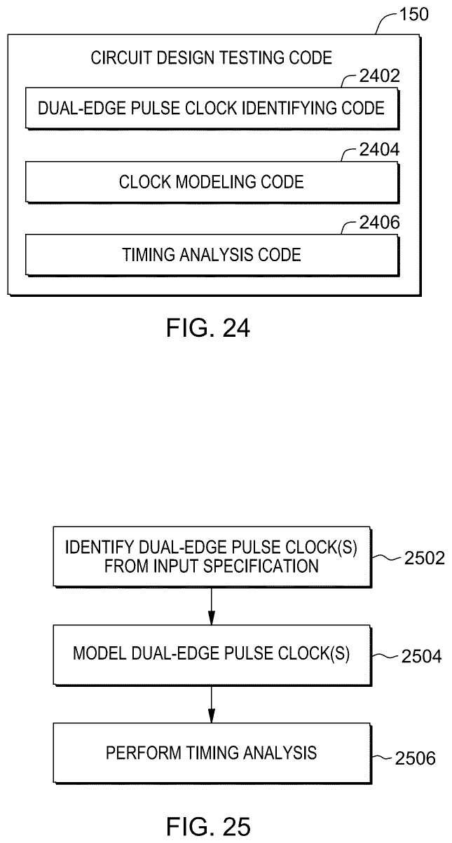

FIG. 25 depicts an example process for circuit design testing in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 25 are part of a module, such as code module 150. In other examples, the code may be included in one or more code modules and/or in one or more code sub-modules of the one or more modules. Various options are available.

In some examples, some or all aspects of the process are performed by a static timing analysis tool (‘timing tool’) itself, though in other examples some or all aspects of the process are performed by a separate component or module, such as a plugin or companion software to the timing tool, or unrelated software that takes the input specification and prepares a modified or augmented input specification based on the processing described.

The process of FIG. 25 includes identifying (2502), from an input specification of a circuit, dual-edge pulse clock(s) that is/are based on a source clock specified in the input specification. An identified dual-edge pulse clock includes leading-edge pulses triggered based on leading edges of the source clock and trailing-edge pulses triggered based on trailing edges of the source clock. The process then models (2504) one (or more) of the identified dual-edge pulse clock(s). A dual-edge pulse clock is modeled by a set of clock signals for a timing analysis of the circuit. The set of clock signals includes a clock signal that models the leading-edge pulses of the dual-edge pulse clock and another clock signal that models the trailing-edge pulses of the dual-edge pulse clock.

In some examples, the modeling includes defining each of the one clock signal and the another clock signal by a respective cycle time, leading edge time, and trailing edge time. Additionally or alternatively, the modeling includes defining leading edges of the one clock signal to correspond to the leading edges of the source clock and/or defines leading edges of the another clock signal to correspond to the trailing edges of the source clock.

In some examples, the dual-edge pulse clock is one clock of a setup test, of a timing analysis to be performed, for testing mid-cycle edge uncertainty of the source clock in a multi-cycle path in which data provided from a latch of the circuit is to be flushed through one or more sequentially-next latches of the circuit and arrive at another latch of the circuit. The testing in this case can be based on an earliest mid-cycle edge arrival time of the source clock and a latest mid-cycle edge arrival time of the source clock. Further, in embodiments, the one dual-edge pulse clock is a modeled dual-edge pulse clock of a plurality of dual-edge pulse clocks identified by the identifying at 2502. The process can model a first dual-edge pulse clock of the plurality of identified dual-edge pulse clocks and a second dual-edge pulse clock of the plurality of identified dual-edge pulse clocks. Either the first pulse clock or the second pulse clock could be the above-mentioned one pulse clock of the plurality of identified dual-edge pulse clocks, or they could be different pulse clocks from the above-mentioned one pulse clock. In any case, modeling the first dual-edge pulse clock of the plurality of identified dual-edge pulse clocks can be based on an early-arrival source clock, which represents the earliest mid-cycle edge arrival time, and use a respective set of clock signals, as early-arrival clock signals. The set can include a first clock signal that models pulses, of the first dual-edge pulse clock, triggered based on leading edges of the early-arrival source clock, and a second clock signal that models pulses, of the first dual-edge pulse clock, triggered based on trailing edges of the early-arrival source clock, where the trailing edges of the early-arrival source clock are mid-cycle edges of the early-arrival source clock. Modeling the second dual-edge pulse clock of the plurality of identified dual-edge pulse clocks can be based on a late-arrival source clock, which represents the latest mid-cycle edge arrival time, and use a respective set of clock signals, as late-arrival clock signals, that includes a first clock signal that models pulses, of the second dual-edge pulse clock, triggered based on leading edges of the late-arrival source clock, and a second clock signal that models pulses, of the second dual-edge pulse clock, triggered based on trailing edges of the late-arrival source clock, where the trailing edges of the late-arrival source clock are mid-cycle edges of the late-arrival source clock.

In addition, the first dual-edge pulse clock could represent one of a first duty cycle waveform and a second duty cycle waveform, where the second clock signal of the early-arrival clock signals includes pulses with leading edges corresponding to the earliest mid-cycle arrival time. Additionally, the second dual-edge pulse clock could represent another/the other of the first duty cycle waveform and the second duty cycle waveform, where the second clock signal of the last-mode clock signals includes pulses with leading edges corresponding to the latest mid-cycle edge arrival time.

In some examples, the process also shifts the pulses of the second clock signal of the late-arrival clock signals earlier by a difference between the latest mid-cycle edge arrival time and the earliest mid-cycle edge arrival time. Alternatively, the method could shift the pulses of the second clock signal of the early-arrival clock signals later by a difference between the latest mid-cycle edge arrival time and the earliest mid-cycle edge arrival time.

Continuing with the process of FIG. 25, the process also performs (2506) the timing analysis based on the modeling of 2504. In examples, the timing analysis includes pulse width testing. The pulse width testing determines pulse width of the leading-edge pulses of the dual-edge pulse clock as a width of pulses of the one clock signal, and determines pulse width of the trailing-edge pulses of the dual-edge pulse clock as a width of pulses of the another clock signal.

Additionally or alternatively, for instance in scenarios of modeling based on an early-arrival source clock and a late-arrival source clock, the timing analysis can include testing mid-cycle edge uncertainty of the source clock in a multi-cycle path in which data provided from a latch of the circuit is to be flushed through one or more sequentially-next latches of the circuit and arrive at another latch of the circuit. The testing can be based on an earliest mid-cycle edge arrival time of the source clock and a latest mid-cycle edge arrival time of the source clock. A setup test, for example, of the timing analysis can be used to test mid-cycle edge uncertainty of the source clock in a multi-cycle path in which data provided from a latch of the circuit is to be flushed through one or more sequentially-next latches of the circuit and arrive at another latch of the circuit, the testing being based on an earliest mid-cycle edge arrival time of the source clock and a latest mid-cycle edge arrival time of the source clock.

In some examples, the method also applies tags to the early-arrival clock signals and the late-arrival clock signals, and performs the timing analysis. Performing the timing analysis can perform a single timing analysis run that uses both the early-arrival clock signals and the late-arrival clock signals and mutually excludes the early-arrival clock signals from the late-arrival clock signals based on the applied tags to avoid conflicts between the early-arrival clock signals and the late-arrival clock signals in the single timing analysis run.

Although various embodiments are described above, these are only examples.

The terminology used herein is for the purpose of describing particular embodiments only and is not intended to be limiting. As used herein, the singular forms “a” “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method including:
identifying, from an input specification of a circuit, a dual-edge pulse clock that is based on a source clock specified in the input specification, the dual-edge pulse clock including leading-edge pulses triggered based on leading edges of the source clock and trailing-edge pulses triggered based on trailing edges of the source clock; and
modeling the dual-edge pulse clock by a set of clock signals for a timing analysis of the circuit, the set of clock signals including one clock signal that models the leading-edge pulses of the dual-edge pulse clock and another clock signal that models the trailing-edge pulses of the dual-edge pulse clock.

2. The method of claim 1, further including performing the timing analysis based on the modeling, wherein the timing analysis includes pulse width testing, the pulse width testing determining pulse width of the leading-edge pulses of the dual-edge pulse clock as a width of pulses of the one clock signal, and determining pulse width of the trailing-edge pulses of the dual-edge pulse clock as a width of pulses of the another clock signal.

3. The method of claim 1, wherein the modeling includes defining each of the one clock signal and the another clock signal by a respective cycle time, leading edge time, and trailing edge time.

4. The method of claim 1, wherein the modeling includes:
defining leading edges of the one clock signal to correspond to the leading edges of the source clock; and
defining leading edges of the another clock signal to correspond to the trailing edges of the source clock.

5. The method of claim 1, wherein the dual-edge pulse clock is one clock of a setup test, of the timing analysis, for testing mid-cycle edge uncertainty of the source clock in a multi-cycle path in which data provided from a latch of the circuit is to be flushed through one or more sequentially-next latches of the circuit and arrive at another latch of the circuit, the testing being based on an earliest mid-cycle edge arrival time of the source clock and a latest mid-cycle edge arrival time of the source clock.

6. The method of claim 5, wherein the dual-edge pulse clock is one dual-edge pulse clock of a plurality of identified dual-edge pulse clocks, wherein the method models:
(i) a first dual-edge pulse clock of the plurality of identified dual-edge pulse clocks based on an early-arrival source clock, representing the earliest mid-cycle edge arrival time, using a respective set of clock signals, as early-arrival clock signals, that includes:
a first clock signal that models pulses, of the first dual-edge pulse clock, triggered based on leading edges of the early-arrival source clock; and
a second clock signal that models pulses, of the first dual-edge pulse clock, triggered based on trailing edges of the early-arrival source clock, the trailing edges of the early-arrival source clock being mid-cycle edges of the early-arrival source clock; and
(ii) a second dual-edge pulse clock of the plurality of identified dual-edge pulse clocks based on a late-arrival source clock, representing the latest mid-cycle edge arrival time, using a respective set of clock signals, as late-arrival clock signals, that includes:
a first clock signal that models pulses, of the second dual-edge pulse clock, triggered based on leading edges of the late-arrival source clock; and
a second clock signal that models pulses, of the second dual-edge pulse clock, triggered based on trailing edges of the late-arrival source clock, the trailing edges of the late-arrival source clock being mid-cycle edges of the late-arrival source clock.

7. The method of claim 6, wherein the first dual-edge pulse clock represents one of a first duty cycle waveform and a second duty cycle waveform, wherein the second clock signal of the early-arrival clock signals includes pulses with leading edges corresponding to the earliest mid-cycle arrival time, wherein the second dual-edge pulse clock represents another of the first duty cycle waveform and the second duty cycle waveform, and wherein the second clock signal of the late-arrival clock signals includes pulses with leading edges corresponding to the latest mid-cycle edge arrival time.

8. The method of claim 7, further including shifting the pulses of the second clock signal of the late-arrival clock signals earlier by a difference between the latest mid-cycle edge arrival time and the earliest mid-cycle edge arrival time.

9. The method of claim 7, further including shifting the pulses of the second clock signal of the early-arrival clock signals later by a difference between the latest mid-cycle edge arrival time and the earliest mid-cycle edge arrival time.

10. The method of claim 7, further including applying tags to the early-arrival clock signals and the late-arrival clock signals, and performing the timing analysis, wherein the performing the timing analysis performs a single timing analysis run that uses both the early-arrival clock signals and the late-arrival clock signals and mutually excludes the early-arrival clock signals from the late-arrival clock signals based on the applied tags to avoid conflicts between the early-arrival clock signals and the late-arrival clock signals in the single timing analysis run.

11. A computer system including:
at least one computing device;
a set of one or more computer readable storage media; and
program instructions, collectively stored in the set of one or more computer readable storage media, for causing the at least one computing device to perform computer operations including:
identifying, from an input specification of a circuit, a dual-edge pulse clock that is based on a source clock specified in the input specification, the dual-edge pulse clock including leading-edge pulses triggered based on leading edges of the source clock and trailing-edge pulses triggered based on trailing edges of the source clock; and
modeling the dual-edge pulse clock by a set of clock signals for a timing analysis of the circuit, the set of clock signals including one clock signal that models the leading-edge pulses of the dual-edge pulse clock and another clock signal that models the trailing-edge pulses of the dual-edge pulse clock.

12. The computer system of claim 11, wherein the computer operations further include performing the timing analysis based on the modeling, wherein the timing analysis includes pulse width testing, the pulse width testing determining pulse width of the leading-edge pulses of the dual-edge pulse clock as a width of pulses of the one clock signal, and determining pulse width of the trailing-edge pulses of the dual-edge pulse clock as a width of pulses of the another clock signal.

13. The computer system of claim 11, wherein the modeling includes:
defining leading edges of the one clock signal to correspond to the leading edges of the source clock; and
defining leading edges of the another clock signal to correspond to the trailing edges of the source clock.

14. The computer system of claim 11, wherein the dual-edge pulse clock is one clock of a setup test, of the timing analysis, for testing mid-cycle edge uncertainty of the source clock in a multi-cycle path in which data provided from a latch of the circuit is to be flushed through one or more sequentially-next latches of the circuit and arrive at another latch of the circuit, the testing being based on an earliest mid-cycle edge arrival time of the source clock and a latest mid-cycle edge arrival time of the source clock, and wherein the dual-edge pulse clock is one dual-edge pulse clock of a plurality of identified dual-edge pulse clocks, wherein the computer operations model:
(i) a first dual-edge pulse clock of the plurality of identified dual-edge pulse clocks based on an early-arrival source clock, representing the earliest mid-cycle edge arrival time, using a respective set of clock signals, as early-arrival clock signals, that includes:
a first clock signal that models pulses, of the first dual-edge pulse clock, triggered based on leading edges of the early-arrival source clock; and
a second clock signal that models pulses, of the first dual-edge pulse clock, triggered based on trailing edges of the early-arrival source clock, the trailing edges of the early-arrival source clock being mid-cycle edges of the early-arrival source clock; and
(ii) a second dual-edge pulse clock of the plurality of identified dual-edge pulse clocks based on a late-arrival source clock, representing the latest mid-cycle edge arrival time, using a respective set of clock signals, as late-arrival clock signals, that includes:
a first clock signal that models pulses, of the second dual-edge pulse clock, triggered based on leading edges of the late-arrival source clock; and
a second clock signal that models pulses, of the second dual-edge pulse clock, triggered based on trailing edges of the late-arrival source clock, the trailing edges of the late-arrival source clock being mid-cycle edges of the late-arrival source clock.

15. The computer system of claim 14, wherein the first dual-edge pulse clock represents one of a first duty cycle waveform and a second duty cycle waveform, wherein the second clock signal of the early-arrival clock signals includes pulses with leading edges corresponding to the earliest mid-cycle arrival time, wherein the second dual-edge pulse clock represents another of the first duty cycle waveform and the second duty cycle waveform, and wherein the second clock signal of the late-arrival clock signals includes pulses with leading edges corresponding to the latest mid-cycle edge arrival time.

16. The computer system of claim 15, wherein the computer operations further include shifting the pulses of the second clock signal of the late-arrival clock signals earlier by a difference between the latest mid-cycle edge arrival time and the earliest mid-cycle edge arrival time, or shifting the pulses of the second clock signal of the early-arrival clock signals later by a difference between the latest mid-cycle edge arrival time and the earliest mid-cycle edge arrival time.

17. The computer system of claim 15, wherein the computer operations further include applying tags to the early-arrival clock signals and the late-arrival clock signals, and performing the timing analysis, wherein the performing the timing analysis performs a single timing analysis run that uses both the early-arrival clock signals and the late-arrival clock signals and mutually excludes the early-arrival clock signals from the late-arrival clock signals based on the applied tags to avoid conflicts between the early-arrival clock signals and the late-arrival clock signals in the single timing analysis run.

18. A computer program product including:
a set of one or more computer readable storage media; and
program instructions, collectively stored in the set of one or more computer readable storage media, for causing at least one computing device to perform computer operations including:
identifying, from an input specification of a circuit, a dual-edge pulse clock that is based on a source clock specified in the input specification, the dual-edge pulse clock including leading-edge pulses triggered based on leading edges of the source clock and trailing-edge pulses triggered based on trailing edges of the source clock; and
modeling the dual-edge pulse clock by a set of clock signals for a timing analysis of the circuit, the set of clock signals including one clock signal that models the leading-edge pulses of the dual-edge pulse clock and another clock signal that models the trailing-edge pulses of the dual-edge pulse clock.

19. The computer program product of claim 18, wherein the computer operations further include performing the timing analysis based on the modeling, wherein the timing analysis includes pulse width testing, the pulse width testing determining pulse width of the leading-edge pulses of the dual-edge pulse clock as a width of pulses of the one clock signal, and determining pulse width of the trailing-edge pulses of the dual-edge pulse clock as a width of pulses of the another clock signal.

20. The computer program product of claim 18, wherein the modeling includes:
defining leading edges of the one clock signal to correspond to the leading edges of the source clock; and
defining leading edges of the another clock signal to correspond to the trailing edges of the source clock.

21. The computer program product of claim 18, wherein the dual-edge pulse clock is one clock of a setup test, of the timing analysis, for testing mid-cycle edge uncertainty of the source clock in a multi-cycle path in which data provided from a latch of the circuit is to be flushed through one or more sequentially-next latches of the circuit and arrive at another latch of the circuit, the testing being based on an earliest mid-cycle edge arrival time of the source clock and a latest mid-cycle edge arrival time of the source clock, and wherein the dual-edge pulse clock is one dual-edge pulse clock of a plurality of identified dual-edge pulse clocks, wherein the computer operations model:
(i) a first dual-edge pulse clock of the plurality of identified dual-edge pulse clocks based on an early-arrival source clock, representing the earliest mid-cycle edge arrival time, using a respective set of clock signals, as early-arrival clock signals, that includes:
a first clock signal that models pulses, of the first dual-edge pulse clock, triggered based on leading edges of the early-arrival source clock; and
a second clock signal that models pulses, of the first dual-edge pulse clock, triggered based on trailing edges of the early-arrival source clock, the trailing edges of the early-arrival source clock being mid-cycle edges of the early-arrival source clock; and
(ii) a second dual-edge pulse clock of the plurality of identified dual-edge pulse clocks based on a late-arrival source clock, representing the latest mid-cycle edge arrival time, using a respective set of clock signals, as late-arrival clock signals, that includes:
a first clock signal that models pulses, of the second dual-edge pulse clock, triggered based on leading edges of the late-arrival source clock; and
a second clock signal that models pulses, of the second dual-edge pulse clock, triggered based on trailing edges of the late-arrival source clock, the trailing edges of the late-arrival source clock being mid-cycle edges of the late-arrival source clock.

22. The computer program product of claim 21, wherein the first dual-edge pulse clock represents one of a first duty cycle waveform and a second duty cycle waveform, wherein the second clock signal of the early-arrival clock signals includes pulses with leading edges corresponding to the earliest mid-cycle arrival time, wherein the second dual-edge pulse clock represents another of the first duty cycle waveform and the second duty cycle waveform, and wherein the second clock signal of the late-arrival clock signals includes pulses with leading edges corresponding to the latest mid-cycle edge arrival time.

23. The computer program product of claim 22, wherein the computer operations further include shifting the pulses of the second clock signal of the late-arrival clock signals earlier by a difference between the latest mid-cycle edge arrival time and the earliest mid-cycle edge arrival time, or shifting the pulses of the second clock signal of the early-arrival clock signals later by a difference between the latest mid-cycle edge arrival time and the earliest mid-cycle edge arrival time.

24. A computer-implemented method including:
identifying, from an input specification of a circuit, a plurality of dual-edge pulse clocks based on a source clock specified in the input specification, each dual-edge pulse clock of the identified plurality of dual-edge pulse clocks including respective leading-edge pulses triggered based on leading edges of the source clock and trailing-edge pulses triggered based on trailing edges of the source clock, wherein the identified plurality of dual-edge pulse clocks are of a setup test, of a timing analysis of the circuit, for testing mid-cycle edge uncertainty of the source clock in a multi-cycle path in which data provided from a latch of the circuit is to be flushed through one or more sequentially-next latches of the circuit and arrive at another latch of the circuit, the testing being based on an earliest mid-cycle edge arrival time of the source clock and a latest mid-cycle edge arrival time of the source clock;
modeling each dual-edge pulse clock of the identified plurality of dual-edge pulse clocks, wherein the modeling models:
(i) a first dual-edge pulse clock of the identified plurality of dual-edge pulse clocks based on an early-arrival source clock, representing the earliest mid-cycle edge arrival time, using a respective set of clock signals, as early-arrival clock signals, that includes:
a first clock signal that models pulses, of the first dual-edge pulse clock, triggered based on leading edges of the early-arrival source clock; and
a second clock signal that models pulses, of the first dual-edge pulse clock, triggered based on trailing edges of the early-arrival source clock, the trailing edges of the early-arrival source clock being mid-cycle edges of the early-arrival source clock; and
(ii) a second dual-edge pulse clock of the identified plurality of dual-edge pulse clocks based on a late-arrival source clock, representing the latest mid-cycle edge arrival time, using a respective set of clock signals, as late-arrival clock signals, that includes:
a first clock signal that models pulses, of the second dual-edge pulse clock, triggered based on leading edges of the late-arrival source clock; and
a second clock signal that models pulses, of the second dual-edge pulse clock, triggered based on trailing edges of the late-arrival source clock, the trailing edges of the late-arrival source clock being mid-cycle edges of the late-arrival source clock; and
performing the timing analysis based on the modeling, wherein the timing analysis includes the setup test for testing mid-cycle edge uncertainty and pulse width testing, the pulse width testing determining pulse width of the respective leading-edge pulses of a selected dual-edge pulse clock, of the identified plurality of dual-edge pulse clocks, as a width of pulses of one clock signal that models the respective leading-edge pulses of the selected dual-edge pulse clock, and determining pulse width of the respective trailing-edge pulses of the selected dual-edge pulse clock as a width of pulses of another clock signal that models the respective trailing-edge pulses of the selected dual-edge pulse clock.

25. A computer system including:
at least one computing device;
a set of one or more computer readable storage media; and
program instructions, collectively stored in the set of one or more computer readable storage media, for causing the at least one computing device to perform computer operations including:
identifying, from an input specification of a circuit, a plurality of dual-edge pulse clocks based on a source clock specified in the input specification, each dual-edge pulse clock of the identified plurality of dual-edge pulse clocks including respective leading-edge pulses triggered based on leading edges of the source clock and trailing-edge pulses triggered based on trailing edges of the source clock, wherein the identified plurality of dual-edge pulse clocks are of a setup test, of a timing analysis of the circuit, for testing mid-cycle edge uncertainty of the source clock in a multi-cycle path in which data provided from a latch of the circuit is to be flushed through one or more sequentially-next latches of the circuit and arrive at another latch of the circuit, the testing being based on an earliest mid-cycle edge arrival time of the source clock and a latest mid-cycle edge arrival time of the source clock;
modeling each dual-edge pulse clock of the identified plurality of dual-edge pulse clocks, wherein the modeling models:
(i) a first dual-edge pulse clock of the identified plurality of dual-edge pulse clocks based on an early-arrival source clock, representing the earliest mid-cycle edge arrival time, using a respective set of clock signals, as early-arrival clock signals, that includes:
a first clock signal that models pulses, of the first dual-edge pulse clock, triggered based on leading edges of the early-arrival source clock; and
a second clock signal that models pulses, of the first dual-edge pulse clock, triggered based on trailing edges of the early-arrival source clock, the trailing edges of the early-arrival source clock being mid-cycle edges of the early-arrival source clock; and
(ii) a second dual-edge pulse clock of the identified plurality of dual-edge pulse clocks based on a late-arrival source clock, representing the latest mid-cycle edge arrival time, using a respective set of clock signals, as late-arrival clock signals, that includes:
a first clock signal that models pulses, of the second dual-edge pulse clock, triggered based on leading edges of the late-arrival source clock; and
a second clock signal that models pulses, of the second dual-edge pulse clock, triggered based on trailing edges of the late-arrival source clock, the trailing edges of the late-arrival source clock being mid-cycle edges of the late-arrival source clock; and
performing the timing analysis based on the modeling, wherein the timing analysis includes the setup test for testing mid-cycle edge uncertainty and pulse width testing, the pulse width testing determining pulse width of the respective leading-edge pulses of a selected dual-edge pulse clock, of the identified plurality of dual-edge pulse clocks, as a width of pulses of one clock signal that models the respective leading-edge pulses of the selected dual-edge pulse clock, and determining pulse width of the respective trailing-edge pulses of the selected dual-edge pulse clock as a width of pulses of another clock signal that models the respective trailing-edge pulses of the selected dual-edge pulse clock.
